(19) United States
(12) Patent Application Publication
(10) Pub. No.: US 2010/0255121 A1
(43) Pub. Date: Oct. 7, 2010

(54) Hard Surface Treatment Compositions with Improved Mold or Fungi Remediation Properties

(75) Inventor: Lisa Perry, Hull (GB)

Correspondence Address: PARFOMAK, ANDREW N.;NORRIS MCLAUGHLIN & MARCUS PA, 875 THIRD AVE, 8TH FLOOR, NEW YORK, NY, 10022, US

(73) Assignee: Reckitt & Colman (Overseas) Limited, Slough Berkshire (GB)

(21) Appl. No.: 12/678,518

(22) PCT Filed: Sep. 15, 2008
(86) PCT No.: PCT/GB2008/003128

§ 371 Date: May 17, 2010

(30) Foreign Application Priority Data
Sep. 21, 2007 (GB) 07148440.1

(51) Int. Cl. A01N 59/00; A01P 3/00

(52) U.S. Cl. 424/665

(57) ABSTRACT

Provided are hard surface treatment compositions which provide improved mold and/or fungi remediation properties which compositions are formed from two aqueous mixtures which are admixed immediately prior to use or upon use. The hard surface treatment compositions contain an oxidizing agent, preferably a hypochlorite. In addition to a mold and/or fungi remediation effect, the composition may also be useful in the cleaning treatment and/or disinfection or sanitization treatment of hard surfaces. Methods for the remediation of mold and/or mold spores and/or fungi on surfaces are also disclosed.

The present invention relates to hard surface treatment compositions which provide improved mold and/or fungi remediation properties. More particularly the present invention relates to hard surface treatment compositions which provide improved mold and/or fungi remediation properties which are formed from two components which are admixed immediately prior to use or upon use. In preferred embodiments hard surface treatment compositions contain an oxidizing agent and in addition to providing a mold and/or fungi remediation effect are also useful in the cleaning treatment and/or disinfection or sanitization treatment of hard surfaces.

Hard surface cleaning and disinfecting compositions are well known and widely used in providing a cleaning and disinfecting effect to surfaces, particularly hard surfaces. Many known art compositions of this type are largely aqueous in nature and are provided either as a concentrate intended to be diluted into a larger volume of water, or may be used as supplied directly from the package or container. While such compositions are widely known and are typically effective against various common species of bacteria, e.g., Staphylococcus aureus (gram positive type pathogenic bacteria) and Salmonella choleraesuis (gram negative type pathogenic bacteria), a majority of such compositions exhibit only limited efficacy against molds and fungi located on hard surfaces. While certain compositions known to the prior art exhibit an immediate mold and/or fungi remediation benefit, e.g., removal of visible mold and/or fungi from surfaces, such benefits are frequently only transitory as regrowth of the mold and/or fungi typically occurs on the order of days or even hours.

Accordingly there exists real and urgent need in the art for hard surface treatment compositions which provide a more durable mold and/or fungi remediation property.

It is to such a need that certain embodiments of the invention are generally directed.

In accordance with a first aspect of the invention there is provided a hard surface treatment composition which provides improved mold and/or fungi remediation properties which composition is formed from two aqueous mixtures which are admixed immediately prior to use or upon use. In preferred embodiments the hard surface treatment composition contains an oxidizing agent. In addition to a mold and/or fungi remediation effect, the composition may also be useful in the cleaning treatment and/or disinfection or sanitization treatment of hard surfaces.

In accordance with a second aspect of the invention there is provided a viscous hard surface treatment composition which provides improved mold and/or fungi remediation properties which viscous composition is formed from two aqueous mixtures which are admixed immediately prior to use or upon use. In preferred embodiments the viscous hard surface treatment composition contains an oxidizing agent. In addition to a mold and/or fungi remediation effect, the composition may also be useful in the cleaning treatment and/or disinfection or sanitization treatment of hard surfaces.

According to a further aspect of the invention there is provided a method for the treatment of hard surfaces wherein the presence of mold and/or fungi is known or suspected, which method includes the step of applying an effective amount of the hard surface treatment composition according to the prior aspect of the invention as a treatment composition for the remediation of said mold and/or fungi which may be present. In addition to the mold and/or fungi remediation effect, the composition may also useful in the cleaning treatment and/or disinfection or sanitization treatment of hard surfaces.

In accordance with a yet further aspect of the invention there is provided a method for producing hard surface treatment composition according to any of the foregoing aspects of the invention, which composition also provides improved mold and/or fungi remediation properties.

According to a further aspect of the invention there is provided a method for treating a surface, particularly a hard surface wherein mold and/or mold spores and/or fungi are present, or are suspected to be present, which method comprises the step of applying a mold and/or fungi remediating quantity of hard surface treatment composition which provides improved mold and/or fungi remediation properties which composition is formed from two aqueous mixtures which are admixed immediately prior to use or upon use to said surface in order to provide a mold and/or fungi remediating benefit thereto; the said hard surface treatment composition may be viscous, or may be essentially water thin.

According to a still further aspect of the invention there is provided a method for providing a durable mold and/or fungi remediation treatment to a surface, particularly a hard surface wherein mold and/or mold spores and/or fungi are present, or are suspected to be present, which method comprises the step of applying a mold and/or fungi remediating quantity of hard surface treatment composition which provides improved mold and/or fungi remediation properties which composition is formed from two aqueous mixtures which are admixed immediately prior to use or upon use to said surface in order to provide a durable mold and/or fungi remediating benefit thereto; he said hard surface treatment composition may be viscous, or may be essentially water thin.

These and further aspects of the invention are described in the following specification.

The present invention provides a hard surface treatment composition which provides improved mold and/or fungi remediation benefits which composition is formed from two aqueous compositions which are admixed shortly before use, but preferably either upon use or upon application to a hard surface. The two compositions are kept separate from one another until they are mixed for use and application to a hard surface. The mixture thus formed is a hard surface treatment composition which provides improved mold and/or fungi remediation properties. Advantageously the hard surface treatment composition is formed by mixing amounts of the first aqueous mixture and the second aqueous mixture as a function of said two mixtures being dispensed from a suitable container or dispensing container, or mixing in a suitable vessel or container to form a hard surface treatment composition intended to be applied to a hard surface shortly, e.g., 10 minutes or less, preferably 5 minutes or less subsequent to mixing, or mixing of the two mixtures directly on a surface upon which the first aqueous mixture and the second aqueous mixture may have been separately or independently applied. The resultant hard surface treatment composition may be applied in any of the foregoing manners to a hard surface wherein the presence of mold and/or fungi are known or suspected.

The first aqueous composition comprises a bleach constituent or an oxidizing constituent, which is collectively referred to as an oxidizing constituent.

Exemplary useful as bleach constituent include those selected from alkali metal and alkaline earth salts of hypohalite, haloamines, haloimines, haloimides and haloamides. All of these are believed to produce hypohalous bleaching species in situ. Hypochlorite and compounds producing hypochlorite in aqueous solution are preferred, although hypobromite is also suitable. Representative hypochlorite-producing compounds include sodium, potassium, lithium and calcium hypochlorite, chlorinated trisodium phosphate dodecahydrate, potassium and sodium dichloroisocyanurate and trichlorocyanuric acid. Organic bleach sources suitable for use include heterocyclic N-bromo and N-chloro imides such as trichlorocyanuric and tribromocyanuric acid, dibromo- and dichlorocyanuric acid, and potassium and sodium salts thereof, N-brominated and N-chlorinated succinimide, malonimide, phthalimide and naphthalimide. Also suitable are hydantoins, such as dibromo- and dichloro dimethylhydantoin, chlorobromodimethyl hydantoin, N-chlorosulfamide (haloamide) and chloramine (haloamine). Particularly preferred for use as the oxidizing constituent is sodium hypochlorite having the chemical formula NaOCl.

The oxidizing constituent may be a peroxyhydrate or other agent which releases hydrogen peroxide in aqueous solution. Such materials are per se, known to the art. Such peroxyhydrates are to be understood as to encompass hydrogen peroxide as well as any material or compound which in an aqueous composition yields hydrogen peroxide. Examples of such materials and compounds include without limitation: alkali metal peroxides including sodium peroxide and potassium peroxide, alkali perborate monohydrates, alkali metal perborate tetrahydrates, alkali metal persulfate, alkali metal percarbonates, alkali metal peroxyhydrate, alkali metal peroxydihydrates, and alkali metal carbonates especially where such alkali metals are sodium or potassium. Further useful are various peroxydihydrate, and organic peroxyhydrates such as urea peroxide.

In addition to the oxidizing constituent it may be advantageous to include a peroxide stabilizer which may be useful in improving the high temperature stability of a peroxide constituent if present, and of the compositions as well. Such a peroxide stabilizer may be one or more known art peroxide stabilizers including, inter alia, one or more organic phosphonates, stannates, pyrophosphates. Further known art peroxide stabilizers include 1-hydroxy-1,1-ethylidene diphosphonate commercially available as DEQUEST 2010 as well as further similar phosphonate compounds. By way of non-limiting example further useful peroxide stabilizers include: amino tri (methylene-phosphonic acid) available as DEQUEST 2000 and DEQUEST 2000LC; amino tri (methylene-phosphonic acid) pentasodium salt available as DEQUEST 2006; 1-hydroxyethylene-1,1,-diphosphonic acid commercially available as DEQUEST 2010; 1-hydroxyethylene-1,1,-diphosphonic acid tetrasodium salt available as DEQUEST 2016 and DEQUEST 2016D; ethylene diamine tetra(methylene phosphonic acid) available as DEQUEST 2041; ethylene diamine tetra(methylene phosphonic acid) pentasodium salt available as DEQUEST 2046; hexamethylenediamine tetra(methylene phosphonic acid) potassium salt available as DEQUEST 2054; diethylenetriamine penta(methylene phosphonic acid) available as DEQUEST 2060S; diethylenetriamine penta (methylenephosphonic acid) trisodium salt available as DEQUEST 2066A; diethylenetriamine penta (methylenephosphonic acid) pentasodium salt available as DEQUEST 2066; diethylenetriamine penta(methylene phosphonic acid) pentasodium salt commercially available as DEQUEST 2066C2; bis-hexamethylene triaminepenta(methylenephosphonic acid) chloride salt commercially available as DEQUEST 2090A 2-phosphonobutane-1,2,4-tricarboxylic acid commercially available as DEQUEST 7000, tetrasodium salt of 1-hydroxy ethyliden (1,1-diphosphonic acid) commercially available as DEQUEST SPE 9528, as well as other materials sold under the DEQUEST tradename, particularly DEQUEST 2086, DEQUEST 3000S, as well as DEQUEST 6004. Other known art compositions or compounds which provide a similar peroxide stabilizing effect may also be used.

With respect to the concentration of the oxidizing constituent, viz., the bleach constituent or an oxidizing constituent present in the first aqueous composition, said oxidizing constituent is advantageously present in an amount of from about 0.001% wt. to about 10% wt., preferably from about 0.01-8% wt., more preferably present in an amount of 0.1-5% wt. and most preferably is present in an amount of about 0.5-3% wt. based on the total weight of the first aqueous composition of which it forms a part.

If present in a composition according to the invention a peroxide stabilizer may be included in the first aqueous composition in any effective amount. Generally, good results are realized when the peroxide stabilizer is present in the first aqueous composition in amounts of from about 0.001-1.2% wt., preferably 0.01-0.5% wt. Such amounts are to be considered in addition to the amount of the oxidizing constituent which is necessarily present in the first aqueous composition.

Desirably the first aqueous composition is alkaline in nature (pH>7) as such improves the stability of the oxidizing constituent in an aqueous environment. Optionally but preferably the first aqueous compositions also include an alkaline constituent which functions as a source of alkalinity for the said compositions. Preferably the alkaline constituent is selected from the group consisting of a hydroxides, a hydroxide generators, buffers, and a mixtures thereof. Exemplary alkaline constituents include alkali metal salts of various inorganic acids, such as alkali metal phosphates, polyphosphates, pyrophosphates, triphosphates, tetraphosphates, silicates, metasilicates, polysilicates, borates, carbonates, bicarbonates, hydroxides, and mixtures of same. A particularly preferred alkaline constituent is an alkali metal hydroxide, especially sodium hydroxide. The alkaline constituent may be included in the first aqueous composition in any amount which is effective in adjusting or maintaining the pH of 10 or more, preferably a pH of 11 or more, and most preferably a pH of 12 or more. While the alkaline constituent may be present in any effective amount in the first aqueous composition to adjust and/or maintain a desired pH, advantageously the alkaline constituent forms 0.01-5% wt., preferably 0.5-3% wt., and most preferably 1-2% wt. of the first aqueous composition of which they form a part.

The second aqueous composition of the invention necessarily comprises a fungicide constituent comprising one or more (N-organyldiazeniumdioxy) compounds and/or metal salts thereof which may be generally represented by the following formula:

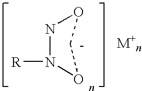

wherein:

R is C₁-C₆-alkyl, C₃-C₈-cycloalkyl or aryl,

M⁺ is a cation equivalent, and

n is an integer from 1 to 3,

With respect to the foregoing metal salts, it is to be specifically understood that the term “alkyl” encompasses both straight-chain, viz, linear, as well as branched alkyl groups, which however are preferably straight-chain or branched C₁-C₄-alkyl groups. Examples of such alkyl groups include: methyl, ethyl, propyl, isopropyl, n-butyl, 2-butyl, sec-butyl, tert-butyl, n-pentyl, 2-pentyl, 2-methylbutyl, 3-methylbutyl, 1,2-dimethylpropyl, 1,1-dimethylpropyl, 2,2-dimethylpropyl, 1-ethylpropyl, n-hexyl, 2-hexyl, 2-methylpentyl, 3-methylpentyl, 4-methylpentyl, 1,2-dimethylbutyl, 1,3-dimethylbutyl, 2,3-dimethylbutyl, 1,1-dimethylbutyl, 2,2-dimethylbutyl, 3,3-dimethylbutyl, 1,1,2-trimethylpropyl, 1,2,2-trimethylpropyl, 1-ethylbutyl, 2-ethylbutyl and 1-ethyl-2-methylpropyl.

The cycloalkyl group is preferably a C₅-C₇-cycloalkyl group such as cyclopentyl, cyclohexyl or cycloheptyl.

The aryl group is preferably phenyl or tolyl.

Preferably R is selected from C₅- and C₆-alkyl or C₅- and C₆-cycloalkyl groups, in particular cyclohexyl.

M⁺ is a cation equivalent, i.e. a monovalent cation, or that portion of a polyvalent cation or a positively charged metal-atom-containing group which corresponds to a single positive charge. For example, M⁺ may be an alkali metal cation such as Li⁺, Na⁺ or K⁺. M⁺ may be a suitable bivalent cation, for example, Cu²⁺, Zn²⁺, Ni²⁺ and Co²⁺. M⁺ may be a suitable trivalent cation, for example, Fe³⁺ and Al³⁺. Suitable monovalent metal-atom-containing groups are, for example, tin-containing groups of the formula R^{a}R^{b}R^{c}Sn⁺ in which R^{a}, R^{b} and R^{c} independently of one another are C₁₋₆-alkyl radicals. Preferred cations are K⁺, Cu²⁺ and Al³⁺. Especially preferred as metal M is potassium.

A particularly preferred (N-organyldiazeniumdioxy) metal salt useful in the compositions of the invention are those which are represented by the following structure:

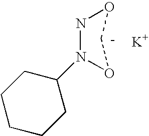

This compound can be identified as the potassium salt of cyclohexyl hydroxyl diazenium-1-oxide, and is presently commercially available as PROTECTOL KD (ex. BASF AG).

Further preferred (N-organyldiazeniumdioxy) compounds useful in the fungicide constituent of the compositions of the invention include bis-N-cyclohexyldiazeniumdioxy-copper as well as tris-N-cyclohexyldiazeniumdioxy-aluminium.

The fungicide constituent may be present in any amount which is observed to be effective in the treatment of hard surfaces wherein the presence of mold and/or fungi is known or suspected. Advantageously the fungicide constituent is present in amounts of from about 0.01-3% wt., preferably 0.05-2% wt., yet more preferably from 0.1-1.5% wt. Although the fungicide constituent might be included in the first aqueous composition, preferably it forms a component of the second aqueous composition and more preferably is absent in the first aqueous composition.

In addition to the fungicide which is selected from bis(N-organyldiazeniumdioxy) compounds, the hard surface treatment composition may additionally include a surface modifying constituent, and in particularly preferred embodiments a surface modifying constituent is necessarily present. The inclusion of the surface modifying constituent is particularly advantageous as the present inventors have surprisingly observed that the hard surface treatment composition exhibits a more durable mold and/or fungi remediation property benefit even in the absence of reapplication of the hard surface treatment composition onto treated hard surfaces for 1, 2, 3 or 4 weeks. Several surface modifying constituents are contemplated.

One class of useful surface modifying constituents include film-forming polymers or other film-forming materials selected from:

a polymer having the formula

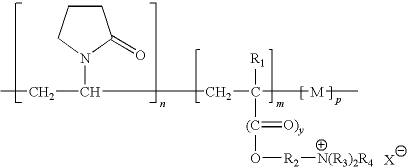

in which n represents from 20 to 99 and preferably from 40 to 90 mol %, m represents from 1 to 80 and preferably from 5 to 40 mol %; p represents 0 to 50 mol, (n+m+p=100); R₁ represents H or CH₃; y represents 0 or 1; R₂ represents —CH₂—CHOH—CH₂— or CₓH₂ₓ in which x is 2 to 18; R₃ represents CH₃, C₂H₅ or t-butyl; R₄ represents CH₃, C₂H₅ or benzyl; X represents Cl, Br, I, ½SO₄, HSO₄ and CH₃SO₃; and M is a vinyl or vinylidene monomer copolymerisable with vinyl pyrrolidone other than the monomer identified in [ ]ₘ;

water soluble polyethylene oxide;

polyvinylpyrrolidone;

high molecular weight polyethylene glycol;

polyvinylcaprolactam;

vinylpyrrolidone/vinyl acetate copolymer;

vinylpyrrolidone/vinyl caprolactam/ammonium derivative terpolymer, especially where the ammonium derivative monomer has 6 to 12 carbon atoms and is selected from diallylamino alkyl methacrylamides, dialkyl dialkenyl ammonium halides, and a dialkylamino alkyl methacrylate or acrylate;

polyvinylalcohol;

cationic cellulose polymer;

film-forming fatty quaternary ammonium compounds;

organosilicone quaternary ammonium polymers;

polyamide polymers;

one or more of which may be present in effective amounts.

A first film-forming polymer contemplated to be useful in the present compositions is one having the formula

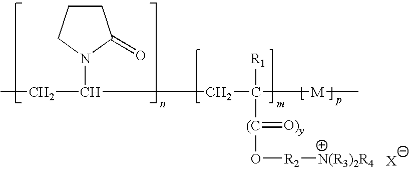

are more fully described in U.S. Pat. No. 4,445,521, U.S. Pat. No. 4,165,367, U.S. Pat. No. 4,223,009, U.S. Pat. No. 3,954,960, as well as GB 1,331,819, the contents of which are hereby incorporated by reference.

The monomer unit within [ ]ₘ is, for example, a di-lower alkylamine alkyl acrylate or methacrylate or a vinyl ether derivative. Examples of these monomers include dimethylaminomethyl acrylate, dimethylaminomethyl methacrylate, diethylaminomethyl acrylate, diethylaminomethyl methacrylate, dimethylaminoethyl acrylate, dimethylaminoethyl methacrylate, dimethylaminobutyl acrylate, dimethylaminobutyl methacrylate, dimethylaminoamyl methacrylate, diethylaminoamyl methacrylate, dimethylaminohexyl acrylate, diethylaminohexyl methacrylate, dimethylaminooctyl acrylate, dimethylaminooctyl methacrylate, diethylaminooctyl acrylate, diethylaminooctyl methacrylate, dimethylaminodecyl methacrylate, dimethylaminododecyl methacrylate, diethylaminolauryl acrylate, diethylaminolauryl methacrylate, dimethylaminostearyl acrylate, dimethylaminostearyl methacrylate, diethylaminostearyl acrylate, diethylaminostearyl methacrylate, di-t-butylaminoethyl methacrylate, di-t-butylaminoethyl acrylate, and dimethylamino vinyl ether.

Monomer M, which can be optional (p is up to 50) can comprise any conventional vinyl monomer copolymerizable with N-vinyl pyrrolidone. Thus, for example, suitable conventional vinyl monomers include the alkyl vinyl ethers, e.g., methyl vinyl ether, ethyl vinyl ether, octyl vinyl ether, etc.; acrylic and methacrylic acid and esters thereof, e.g., methacrylate, methyl methacrylate, etc.; vinyl aromatic monomers, e.g., styrene, a-methyl styrene, etc; vinyl acetate; vinyl alcohol; vinylidene chloride; acrylonitrile and substituted derivatives thereof; methacrylonitrile and substituted derivatives thereof; acrylamide and methacrylamide and N-substituted derivatives thereof; vinyl chloride, crotonic acid and esters thereof; etc. Again, it is noted that such optional copolymerizable vinyl monomer can comprise any conventional vinyl monomer copolymerizable with N-vinyl pyrrolidone. These materials may generally provided as a technical grade mixture which includes the polymer dispersed in an aqueous or aqueous/alcoholic carrier. Such include materials which are presently commercially available include quaternized copolymers of vinylpyrrolidone and dimethylaminoethyl methacrylate sold as Gafquat® copolymers (ex. ISP Corp., Wayne, N.J.) which are available in a variety of molecular weights.

Further exemplary useful examples of the film-forming polymers of the present invention include quaternized copolymers of vinylpyrrolidone and dimethylaminoethyl methacrylate as described in U.S. Pat. No. 4,080,310, to Ng, the contents of which are herein incorporated by reference. Such quaternized copolymers include those according to the general formula:

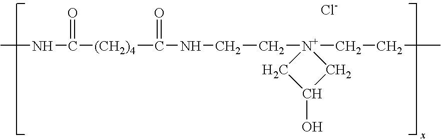

wherein “x” is about 40 to 60. Further exemplary useful copolymers include copolymers of vinylpyrrolidone and dimethylaminoethylmethacrylate quaternized with diethyl sulphate (available as Gafquat® 755 ex., ISP Corp., Wayne, N.J.).

One exemplary useful film-forming polymer is a quaternized polyvinylpyrrolidone/dimethylamino ethylmethacrylate copolymer which is commercially available as Gafquat® 734, is disclosed by its manufacturer to be:

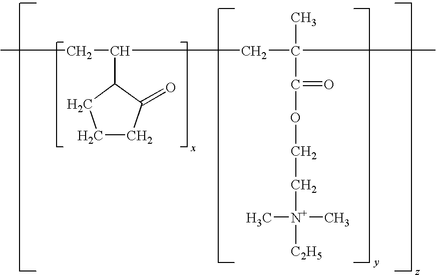

wherein x, y and z are at least 1 and have values selected such that the total molecular weight of the quaternized polyvinylpyrrolidone/dimethylamino ethylmethacrylate copolymer is at least 10,000 more desirably has an average molecular weight of 50,000 and most desirably exhibits an average molecular weight of 100,000. A further useful, but less preferred quaternized polyvinylpyrrolidone/dimethylamino ethylmethacrylate copolymer is available as Gafquat® 755N which is similar to the Gafquat® 734 material describe above but has an average molecular weight of about 1,000,000. These materials are sometimes referred to as “Polyquaternium-11”.

Polyethylene oxides for use as film-forming polymers in the compositions according to the invention may be represented by the following structure:

(CH₂CH₂O)ₓ

where:
x has a value of from about 2000 to about 180,000.
Desirably, these polyethylene oxides may be further characterized as water soluble resins, having a molecular weight in the range of from about 100,000 to about 8,000,000. At room temperature (68° F., 20° C.) they are solids. Particularly useful as the film-forming, water soluble polyethylene oxide in the inventive compositions are POLYOX water-soluble resins (ex. Union Carbide Corp., Danbury Conn.).
Further contemplated as useful in the place of, or in combination with these polyethylene oxides are polypropylene oxides, or mixed polyethylene oxides-polypropylene oxides having molecular weights in excess of about 50,000 and if present, desirably having molecular weights in the range of from about 100,000 to about 8,000,000. According to particularly desirable embodiments of the invention, the film-forming constituent of the present invention is solely a water soluble polyethylene oxide.

Exemplary useful polyvinylpyrrolidone polymers useful as film-forming polymers in the present inventive compositions include those which exhibit a molecular weight of at least about 5,000, with a preferred molecular weight of from about 6,000-3,000,000. The polyvinylpyrrolidone is generally provided as a technical grade mixture of polyvinylpyrrolidone polymers within approximate molecular weight ranges.

Exemplary useful polyvinylpyrrolidone polymers are available in the PVP line materials (ex. ISP Corp.) which include PVP K 15 polyvinylpyrrolidone described as having molecular weight in the range of from 6,000-15,000; PVP-K 30 polyvinylpyrrolidone with a molecular weight in the range of 40,000-80,000; PVP-K 60 polyvinylpyrrolidone with a molecular weight in the range of 240,000-450,000; PVP-K 90 polyvinylpyrrolidone with a molecular weight in the range of 900,000-1,500,000; PVP-K 120 polyvinylpyrrolidone with a molecular weight in the range of 2,000,000-3,000,000. Further preferred examples of polyvinylpyrrolidones are described in the Examples.

Other suppliers of polyvinylpyrrolidones include AllChem Industries Inc, Gainesville, Fla., Kraft Chemical Co., Melrose Park, Ill., Alfa Aesar, a Johnson Matthey Co., Ward Hill, Mass., and Monomer-Polymer & Dajac Labs Inc., Feasterville, Pa.

High molecular weight polyethylene glycol polymers useful as film-forming polymers in the present inventive compositions exhibit a molecular weight of at least about 100, preferably exhibits a molecular weight in the range of from about 100 to about 10,000 but most preferably a molecular weight in the range of from about 2000 to about 10,000.

Particularly useful high molecular weight polyethylene glycols are available under the tradename CARBOWAX® (ex. Union Carbide Corp.). Other suppliers of high molecular weight polyethylene glycols include Ashland Chemical Co., BASF Corp., Norman, Fox & Co., and Shearwater Polymers, Inc.

Exemplary film-forming polymers include polyvinylcaprolactams such as polyvinylcaprolactam compounds marketed under the tradename LUVISKOL® (ex. BASF Corp.). Such polyvinylcaprolactams may be represented by the following structural formula:

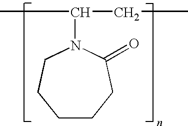

Where n has a value of at least about 800, and preferably a value in the range of from about 500 to about 1000.

Exemplary vinylpyrrolidone/vinylacetate copolymers which find use as film-forming polymers in the present inventive compositions include those vinylpyrrolidone, vinylacetate copolymers, examples of which are presently commercially available. Such vinylpyrrolidone/vinylacetate copolymers are comprised of vinylpyrrolidone monomers which may be represented by the following structural formula:

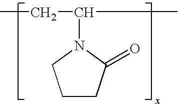

and vinylacetate monomers which may be represented by the following structural formula:

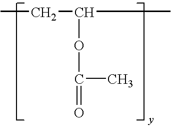

which are usually formed by a free-radical polymerization reaction to produce linear random vinylpyrrolidone/vinylacetate copolymers. The resultant vinylpyrrolidone/vinylacetate copolymers may comprise varying amounts of the individual vinylpyrrolidone monomers and vinylacetate monomers, with ratios of vinylpyrrolidone monomer to vinylacetate monomers from 30/70 to 70/30. The values of x and y in the structural formula should have values such that x+y=100 to 500, preferably x+y=150 to 300. Such values correspond to provide vinylpyrrolidone/vinylacetate copolymers having a total molecular weight in the range from about 10,000 to about 100,000, preferably from about 12,000 to about 60,000. Desirably the ratio of x: y is 0.1:4.0, preferably from 0.2:3.0. Such ratios of x:y provide the preferred vinylpyrrolidone/vinylacetate copolymers which have vinylpyrrolidone monomer to vinylacetate monomers from 0.3/2.5.

Such vinylpyrrolidone/vinylcaprolactam/ammonium derivative terpolymers are comprised of vinylpyrrolidone monomers which may be represented by the following structural formula:

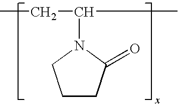

and vinylcaprolactam monomers which may be represented by the following structural formula:

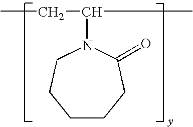

and dimethylaminoethylmethacrylate monomers which may be represented by the following structural formula:

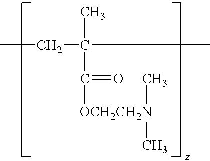

Exemplary vinylpyrrolidone/vinylcaprolactam/ammonium derivative terpolymer wherein the ammonium derivative monomer has 6 to 12 carbon atoms and is selected from diallylamino alkyl methacrylamides, dialkyl dialkenyl ammonium halides, and a dialkylamino alkyl methacrylate or acrylate which find use in the present inventive compositions include those marketed under the tradename ADVANTAGE® (ex. ISP.) as well as GAFFIX® (ex. ISP Corp). Such terpolymers are usually formed by a free-radical polymerization reaction to produce linear random vinylpyrrolidone/vinylcaprolactam/ammonium derivative terpolymers. The vinylpyrrolidone/vinylcaprolactam/ammonium derivative terpolymers useful in the present invention preferably comprise 17-32 weight % vinylpyrrolidone; 65-80 weight % vinylcaprolactam; 3-6 weight % ammonium derivative and 0-5 weight % stearyl methacrylate monomers. The polymers can be in the form of random, block or alternating structure having number average molecular weights ranging between about 20,000 and about 700,000; preferably between about 25,000 and about 500,000. The ammonium derivative monomer preferably has from 6 to 12 carbon atoms and is selected from the group consisting of dialkylaminoalkyl methacrylamide, dialkyl dialkenyl ammonium halide and a dialkylamino alkyl methacrylate or acrylate. Examples of the ammonium derivative monomer include, for example, dimethylamino propyl methacrylamide, dimethyl diallyl ammonium chloride, and dimethylamino ethyl methacrylate (DMAEMA). These terpolymers are more fully described in U.S. Pat. No. 4,521,404 to GAF Corporation, the contents of which are hereby incorporated by reference.

Exemplary film-forming polyvinylalcohols which find use in the present inventive compositions include those marketed under the tradename Airvol® (Air Products Inc., Allentown Pa.). These include: Airvol® 125, classified as a “super hydrolyzed” polyvinylalcohol polymer having a degree of hydrolysis of at least 99.3%, and a viscosity at a 4% solution in 20° C. water of from 28-32 cps; Airvol® 165, and Airvol® 165S, each being classified as “super hydrolyzed” polyvinylalcohol polymer having a degree of hydrolysis of at least 99.3%, and a viscosity at a 4% solution in 20° C. water of from 62-72 cps; Airvol® 103, classified as a “fully hydrolyzed” polyvinylalcohol polymer having a degree of hydrolysis of from 98.0-98.8%, and a viscosity at a 4% solution in 20° C. water of from 3.5-4.5 cps; Airvol® 305, classified as a “fully hydrolyzed” polyvinylalcohol polymer having a degree of hydrolysis of from 98.0-98.8%, and a viscosity at a 4% solution in 20° C. water of from 4.5-5.5 cps; Airvol® 107, classified as a “fully hydrolyzed” polyvinylalcohol polymer having a degree of hydrolysis of from 98.0-98.8%, and a viscosity at a 4% solution in 20° C. water of from 5.5-6.6 cps; Airvol® 321, classified as a “fully hydrolyzed” polyvinylalcohol polymer having a degree of hydrolysis of from 98.0-98.8%, and a viscosity at a 4% solution in 20° C. water of from 16.5-20.5 cps; Airvol® 325, classified as a “fully hydrolyzed” polyvinylalcohol polymer having a degree of hydrolysis of from 98.0-98.8%, and a viscosity at a 4% solution in 20° C. water of from 28-32 cps; and Airvol®350, classified as a “fully hydrolyzed” polyvinylalcohol polymer having a degree of hydrolysis of from 98.0-98.8%, and a viscosity at a 4% solution in 20° C. water of from 62-72 cps; Airvol® 425, classified as being an “intermediate hydrolyzed” polyvinylalcohol polymer classified having a degree of hydrolysis of from 95.5-96.5%, and a viscosity at a 4% solution in 20° C. water of from 27-31 cps; Airvol® 502, classified as a “partially hydrolyzed” polyvinylalcohol polymer having a degree of hydrolysis of from 87.0-89.0%, and a viscosity at a 4% solution in 20° C. water of from 3.0-3.7 cps; Airvol® 203 and Airvol® 203S, each classified as a “partially hydrolyzed” polyvinylalcohol polymer having a degree of hydrolysis of from 87.0-89.0%, and a viscosity at a 4% solution in 20° C. water of from 3.5-4.5 cps; Airvol® 205 and Airvol® 205S, each classified as a “partially hydrolyzed” polyvinylalcohol polymer having a degree of hydrolysis of from 87.0-89.0%, and a viscosity at a 4% solution in 20° C. water of from 5.2-6.2 cps; Airvol® 523, classified as a “partially hydrolyzed” polyvinylalcohol polymer having a degree of hydrolysis of from 87.0-89.0%, and a viscosity at a 4% solution in 20° C. water of from 23-27 cps; and Airvol® 540, each classified as a “partially hydrolyzed” polyvinylalcohol polymer having a degree of hydrolysis of from 87.0-89.0%, and a viscosity at a 4% solution in 20° C. water of from 45-55 cps.

Particularly preferred are polyvinyl alcohol polymers which exhibit a degree of hydrolysis in the range of from 87%-89% and which desirably also exhibit a viscosity at a 4% solution in 20° C. water of from 3.0-100.0 cps.

Exemplary cationic cellulose polymers which find use as the film-forming polymers in the present inventive compositions have been described in U.S. Pat. No. 5,830,438 as being a copolymer of cellulose or of a cellulose derivative grafted with a water-soluble monomer in the form of quaternary ammonium salt, for example, halide (e.g., chloride, bromide, iodide), sulfate and sulfonate. Such polymers are described in U.S. Pat. No. 4,131,576 to National Starch & Chemical Company, the contents of which are hereby hydroxyethyl- and hydroxypropylcelluloses grafted with a salt of methacryloylethyltrimethyl ammonium, methacrylamidopropyltrimethyl ammonium, or dialkyldiallyl ammonium, wherein each alkyl has at least one carbon atom and wherein the number of carbon atoms is such that the material is water soluble, preferably from 1 to about 20 carbon atoms, more preferably from 1 to about 10 carbon atoms, such as methyl, ethyl, propyl, butyl and the like. The preferred materials can be purchased for example under the trademarks “Celquat L 200” and “Celquat H 100” from National Starch & Chemical Company.

Useful film-forming polymers include cationic cellulose polymers which are, per se, generally known. Exemplary cationic cellulose polymers useful in the present inventive compositions exhibit generally a viscosity of about 1,000 cps (as taken from a product specification of Celquat H-100; measured as 2% solids in water using an RVF Brookfield Viscometer, #2 spindle at 20 rpm and 21° C.).

Further useful as the film-forming polymer in the compositions of the present invention include film forming cationic polymers, and especially, film-forming fatty quaternary ammonium compounds which generally conform to the following structure:

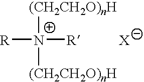

wherein R is a fatty alkyl chain, e.g., C₈-C₃₂ alkyl chain such as tallow, coco, stearyl, etc., R′ is a lower C₁-C₆ alkyl or alkylene group, the sum of both n is between 12-48, and X is a salt-forming counterion which renders the compound water soluble or water dispersible, e.g., an alkali, alkaline earth metal, ammonium, methosulfate as well as C₁-C₄ alkyl sulfates.

A particularly preferred film forming film-forming fatty quaternary ammonium compound may be represented by the following structure:

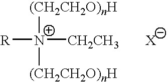

wherein R is a fatty alkyl chain, e.g., C₈-C₃₂ alkyl chain such as tallow, coco, stearyl, etc., the sum of both “n” is between 12-48, and preferably the value of each n is the same as the other, and X is a salt-forming counterion such as an alkali, alkaline earth metal, ammonium, methosulfate but is preferably an alkyl sulfate such as ethyl sulfate but especially diethyl sulfate. An preferred example of a commercially available material which may be advantageously used is CRODAQUAT TES (ex. Croda Inc., Parsippany, N.J.) described to be polyoxyethylene (16) tallow ethylammonioum ethosfulfate. A further preferred commercially available material is CRODAQUAT 1207 (ex. Croda Inc.)

A further class of particularly useful film-forming polymers include film-forming, organosilicone quaternary ammonium compounds. Such compounds may also exhibit antimicrobial activity, especially on hard surfaces which may supplement the effect of the quaternary ammonium surfactant compounds having germicidal properties.

Specific examples of organosilicone quaternary ammonium salts that may be used in the compositions of this invention include organosilicone derivatives of the following ammonium salts: di-isobutylcresoxyethoxyethyl dimethyl benzyl ammonium chloride, di-isobutylphenoxyethoxyethyl dimethyl benzyl ammonium chloride, myristyl dimethylbenzyl ammonium chloride, myristyl picolinium chloride, N-ethyl morpholinium chloride, laurylisoquinolinium bromide, alkyl imidazolinium chloride, benzalkonium chloride, cetyl pyridinium chloride, coconut dimethyl benzyl ammonium chloride, stearyl dimethyl benzyl ammonium chloride, alkyl dimethyl benzyl ammonium chloride, alkyl diethyl benzyl ammonium chloride, alkyl dimethyl benzyl ammonium bromide, di-isobutyl phenoxyethoxyethyl trimethyl ammonium chloride, di-isobutylphenoxyethoxyethyl dimethyl alkyl ammonium chloride, methyl-dodecylbenzyl trimethyl ammonium chloride, cetyl trimethyl ammonium bromide, octadecyl dimethyl ethyl ammonium bromide, cetyl dimethyl ethyl ammonium bromide, octadec-9-enyl dimethyl ethyl ammonium bromide, dioctyl dimethyl ammonium chloride, dodecyl trimethyl ammonium chloride, octadecyl trimethyl ammonium chloride, octadecyl trimethyl ammonium bromide, hexadecyl trimethyl ammonium iodide, octyl trimethyl ammonium fluoride, and mixtures thereof. Other water dispersible salts, such as the acetates, sulfates, nitrates, and phosphates, are effective in place of the halides, but the chlorides and bromides are preferred. The silicone group is preferably substituted with alkyl ethers. Preferred alkyl ethers are short carbon chain ethers such as methoxy and ethoxy sub stituents.

Still further examples of particularly preferred film-forming, organosilicone quaternary ammonium compounds which find use in the present inventive compositions include those which may be represented by the following structural representation:

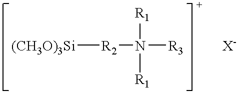

wherein:
R₁ and R₂ each independently represent short chain alkyl or alkenyl groups, preferably C₁-C₈ alkyl or alkenyl groups;
R₃ represents a C₁₁-C₂₂ alkyl group; and
X represents a salt forming counterion, especially a halogen.

Preferred short chain alkyl substituents for R₁ are methyl and ethyl, preferred short chain alkyl substituents for R₂ are straight chain links of methylene groups consisting of from 1 to 4 members, preferred R₃ substituents are straight chain links of methylene groups consisting of from 11 to 22 members, and preferred halogens for X are chloride and bromide.

An exemplary particularly preferred and commercially available film-forming, organosilicone quaternary ammonium compounds useful in the inventive compositions is AEM® 5772 or AEM® 5700 (from Aegis Environmental Co., Midland, Mich.). Both of these materials are described as being 3-(trimethoxysilyl)propyloctadecyldimethyl ammonium chloride, AEM® 5700 and is sold as a 72% by weight active solution of the compound in a water/methanol mixture, while AEM® 5772 is sold as a 72% by weight active solution of the compound in a water/methanol mixture.

A further material which is contemplated to be useful in the present inventive compositions as a film-forming material includes materials currently being sold under the VIVIPRINT tradename, e.g., VIVIPRINT 131, which is described to be 2-propenamide, N-[3-(dimethylamino)propyl]-2-methyl, polymer with 1-ethenyl-2-pyrrolidone hydrochloride.

It is of course contemplated that a mixture or blend of two or more distinct compounds may be used to provide the surface modifying constituent of the inventive compositions.

Additional useful surface modifying constituents include silicon containing compounds including but not limited to siloxane, polysiloxanes and silanes. Non-limiting examples of useful silicon containing compounds include but are not limited to: dimethicones, dimethicone copolyol, dimethylpolysiloxane, diethylpolysiloxane, high molecular weight dimethicone, mixed C₁-C₃₀ alkyl polysiloxane, phenyl dimethicone, dimethiconol, and mixtures thereof. More preferred are non-volatile silicones selected from dimethicone, dimethiconol, mixed C₁-C₃₀ alkyl polysiloxane, and mixtures thereof. Particularly preferred silicon containing compounds include those described with reference to one or more of the following examples.

The surface modifying constituent based on one or more of the foregoing film-forming polymers and/or one or more of the film-forming materials and/or surface modifying constituents include silicon containing compounds may be present in any amount which is observed to be effective in the treatment of hard surfaces wherein the presence of mold and/or fungi is known or suspected. Based on the total weight of the hard surface treatment composition formed from the mixture of the at least first aqueous composition and the second aqueous composition, advantageously the said one or more of the foregoing surface modifying constituents is present in amounts of from about 0.001-10% wt., preferably 0.2-8% wt., yet more preferably from 0.4-5% wt., still more preferably 0.4-4% wt. and most preferably 0.5-3% wt.

While the surface modifying constituent may present in the first aqueous composition, second aqueous composition or for that matter any aqueous composition which is used to form the hard surface treatment composition, advantageously the surface modifying constituent is present in the same aqueous composition in which the fungicide constituent is also preset. Alternately the surface modifying constituent is preferably present in any aqueous composition which does not contain the oxidizing constituent. Thus, based on the total weight of the hard surface treatment composition formed from the mixture of the at least first aqueous composition and the second aqueous composition, advantageously the said one or more of the foregoing surface modifying constituents are present in an aqueous composition which is used to form the treatment composition in amounts of from about 0.002-20% wt., preferably 0.4-16% wt., yet more preferably from 0.8-10% wt., still more preferably 0.8-8% wt. and most preferably 1-6% wt.

The surface modifying constituent may generally provided as a technical grade mixture which includes a film-forming polymer or other film-forming material dispersed in an aqueous or aqueous/alcoholic carrier.

According to certain further preferred embodiments, a surface modifying constituent is necessarily present in the hard surface treatment compositions taught herein.

The hard surface treatment compositions of the invention optionally but desirably comprise one or more known art cleaning agents or cleaning constituents known to those of ordinary skill in the relevant art, and without limitation include one or more detersive surfactants selected from anionic, cationic, nonionic as well as amphoteric or zwitterionic surfactants. In particularly preferred embodiments the compositions of the invention necessarily include at least one known art cleaning agents or cleaning constituents and especially one or more surfactants.

Exemplary of anionic surfactants which may be present include alcohol sulfates and sulfonates, alcohol phosphates and phosphonates, alkyl ester sulfates, alkyl diphenyl ether sulfonates, alkyl sulfates, alkyl ether sulfates, sulfate esters of an alkylphenoxy polyoxyethylene ethanol, alkyl monoglyceride sulfates, alkyl sulfonates, alkyl ether sulfates, alpha-olefin sulfonates, beta-alkoxy alkane sulfonates, alkyl ether sulfonates, ethoxylated alkyl sulfonates, alkylaryl sulfonates, alkylaryl sulfates, alkyl monoglyceride sulfonates, alkyl carboxylates, alkyl ether carboxylates, alkyl alkoxy carboxylates having 1 to 5 moles of ethylene oxide, alkylpolyglycolethersulfates (containing up to 10 moles of ethylene oxide), sulfosuccinates, octoxynol or nonoxynol phosphates, taurates, fatty taurides, fatty acid amide polyoxyethylene sulfates, acyl glycerol sulfonates, fatty oleyl glycerol sulfates, alkyl phenol ethylene oxide ether sulfates, paraffin sulfonates, alkyl phosphates, isethionates, N-acyl taurates, alkyl succinamates and sulfosuccinates, alkylpolysaccharide sulfates, alkylpolyglucoside sulfates, alkyl polyethoxy carboxylates, and sarcosinates or mixtures thereof. These anionic surfactants may be provided as salts with one or more organic counterions, e.g, ammonium, or inorganic counteraions, especially as salts of one or more alkaline earth or alkaline earth metals, e.g, sodium.

Further examples of anionic surfactants include water soluble salts or acids of the formula (ROSO₃)ₓM or (RSO₃)ₓM wherein R is preferably a C₆-C₂₄ hydrocarbyl, preferably an alkyl or hydroxyalkyl having a C₁₀-C₂₀ alkyl component, more preferably a C₁₂-C₁₈ alkyl or hydroxyalkyl, and M is H or a mono-, di- or tri-valent cation, e.g., an alkali metal cation (e.g., sodium, potassium, lithium), or ammonium or substituted ammonium (e.g., methyl-, dimethyl-, and trimethyl ammonium cations and quaternary ammonium cations, such as tetramethyl-ammonium and dimethyl piperidinium cations and quaternary ammonium cations derived from alkylamines such as ethylamine, diethylamine, triethylamine, and mixtures thereof, and the like) and x is an integer, preferably 1 to 3, most preferably 1. Materials sold under the Hostapur and Biosoft trademarks are examples of such anionic surfactants.

Still further examples of anionic surfactants include alkyl-diphenyl-ethersulphonates and alkyl-carboxylates.

Also useful as anionic surfactants are diphenyl disulfonates, and salt forms thereof, such as a sodium salt of diphenyl disulfonate commercially available as Dowfax® 3B2. Such diphenyl disulfonates are included in certain preferred embodiments of the invention in that they provide not only a useful cleaning benefit but concurrently also provide a useful degree of hydrotropic functionality.

Other anionic surfactants can include salts (including, for example, sodium, potassium, ammonium, and substituted ammonium salts such as mono-, di- and triethanolamine salts) of soap, C₆-C₂₀ linear alkylbenzenesulfonates, C₆-C₂₂ primary or secondary alkanesulfonates, C₆-C₂₄ olefinsulfonates, sulfonated polycarboxylic acids prepared by sulfonation of the pyrolyzed product of alkaline earth metal citrates, C₆-C₂₄ alkylpolyglycolethersulfates, alkyl ester sulfates such as C₁₄₋₁₆ methyl ester sulfates; acyl glycerol sulfonates, fatty oleyl glycerol sulfates, alkyl phenol ethylene oxide ether sulfates, paraffin sulfonates, alkyl phosphates, isethionates such as the acyl isethionates, N-acyl taurates, alkyl succinamates and sulfosuccinates, monoesters of sulfosuccinate (especially saturated and unsaturated C₁₂-C₁₈ monoesters) diesters of sulfosuccinate (especially saturated and unsaturated C₆-C₁₄ diesters), acyl sarcosinates, sulfates of alkylpolysaccharides such as the sulfates of alkylpolyglucoside, branched primary alkyl sulfates, alkyl polyethoxy carboxylates such as those of the formula RO(CH₂CH₂O)ₖCH₂COO⁻M⁺ wherein R is a C₈-C₂₂ alkyl, k is an integer from 0 to 10, and M is a soluble salt-forming cation. Examples of the foregoing anionic surfactants are available under the following tradenames: Rhodapon®, Stepanol®, Hostapur®, Surfine®, Sandopan®, Neodox®, Biosoft®, and Avanel®.

An anionic surfactant compound which may be particularly useful in the inventive compositions when the compositions are at a pH of 2 or less are one or more anionic surfactants based on alphasulphoesters including one or more salts thereof. Such particularly preferred anionic surfactants may be represented by the following general structures:

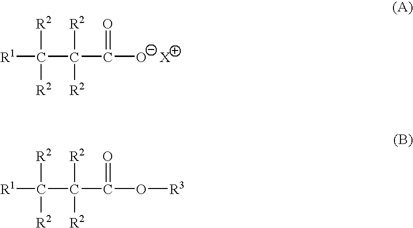

wherein, in each of the foregoing:
R¹ represents a C₆-C₂₂ alkyl or alkenyl group;
each of R² is either hydrogen, or if not hydrogen is a SO₃⁻ having associated with it a cation, X⁺, which renders the compound water soluble or water dispersible, with X preferably being an alkali metal or alkaline earth metal especially sodium or potassium, especially sodium, with the proviso that at least one R², preferably at least two R² is a (SO₃⁻) having an associated cation X⁺, and,
R³ represents a C₁-C₆, preferably C₁-C₄ lower alkyl or alkenyl group, especially methyl.

According to certain preferred embodiments, anionic surfactants are however expressly excluded from the compositions of the present invention.

One class of exemplary useful nonionic surfactants are polyethylene oxide condensates of alkyl phenols. These compounds include the condensation products of alkyl phenols having an alkyl group containing from about 6 to 12 carbon atoms in either a straight chain or branched chain configuration with ethylene oxide, the ethylene oxide being present in an amount equal to 5 to 25 moles of ethylene oxide per mole of alkyl phenol. The alkyl substituent in such compounds can be derived, for example, from polymerized propylene, diisobutylene and the like. Examples of compounds of this type include nonyl phenol condensed with about 9.5 moles of ethylene oxide per mole of nonyl phenol; dodecylphenol condensed with about 12 moles of ethylene oxide per mole of phenol; dinonyl phenol condensed with about 15 moles of ethylene oxide per mole of phenol and diisooctyl phenol condensed with about 15 moles of ethylene oxide per mole of phenol.

Further useful nonionic surfactants include the condensation products of aliphatic alcohols with from about 1 to about 60 moles of ethylene oxide. The alkyl chain of the aliphatic alcohol can either be straight or branched, primary or secondary, and generally contains from about 8 to about 22 carbon atoms. Examples of such ethoxylated alcohols include the condensation product of myristyl alcohol condensed with about 10 moles of ethylene oxide per mole of alcohol and the condensation product of about 9 moles of ethylene oxide with coconut alcohol (a mixture of fatty alcohols with alkyl chains varying in length from about 10 to 14 carbon atoms). Other examples are those C₆-C₁₁ straight-chain alcohols which are ethoxylated with from about 3 to about 6 moles of ethylene oxide. Their derivation is well known in the art. Examples include Alfonic® 810-4.5 (also available as Teric G9A5), which is described in product literature from Sasol as a C₈₋₁₀ having an average molecular weight of 356, an ethylene oxide content of about 4.85 moles (about 60 wt. %), and an HLB of about 12; Alfonic® 810-2, which is described in product literature from Sasol as a C₈₋₁₀ having an average molecular weight of 242, an ethylene oxide content of about 2.1 moles (about 40 wt. %), and an HLB of about 12; and Alfonic® 610-3.5, which is described in product literature from Sasol as having an average molecular weight of 276, an ethylene oxide content of about 3.1 moles (about 50 wt. %), and an HLB of 10. Product literature from Sasol also identifies that the numbers in the alcohol ethoxylate name designate the carbon chain length (numbers before the hyphen) and the average moles of ethylene oxide (numbers after the hyphen) in the product.

Further exemplary useful nonionic surfactants include ethoxylated available from Shell Chemical Company which are described as C₉-C₁₁ ethoxylated alcohols and marketed under the Neodol® tradename. The Neodol® 91 series non-ionic surfactants of interest include Neodol 91-2.5, Neodol 91-6, and Neodol 91-8. Neodol 91-2.5 has been described as having about 2.5 ethoxy groups per molecule; Neodol 91-6 has been described as having about 6 ethoxy groups per molecule; and Neodol 91-8 has been described as having about 8 ethoxy groups per molecule. Still further examples of ethoxylated alcohols include the Rhodasurf® DA series non-ionic surfactants available from Rhodia which are described to be branched isodecyl alcohol ethoxylates. Rhodasurf DA-530 has been described as having 4 moles of ethoxylation and an HLB of 10.5; Rhodasurf DA-630 has been described as having 6 moles of ethoxylation with an HLB of 12.5; and Rhodasurf DA-639 is a 90% solution of DA-630.

Further examples of ethoxylated alcohols include those from Tomah Products (Milton, Wis.) under the Tomadol tradename with the formula RO(CH₂CH₂O)ₙH where R is the primary linear alcohol and n is the total number of moles of ethylene oxide. The ethoxylated alcohol series from Tomah include 91-2.5; 91-6; 91-8—where R is linear C9/C10/C11 and n is 2.5, 6, or 8; 1-3; 1-5; 1-7; 1-73B; 1-9;—where R is linear C11 and n is 3, 5, 7 or 9; 23-1; 23-3; 23-5; 23-6.5—where R is linear C12/C13 and n is 1, 3, 5, or 6.5; 25-3; 25-7; 25-9; 25-12—where R is linear C12/C13 C14/C15 and n is 3, 7, 9, or 12; and 45-7; 45-13—where R is linear C14/C15 and n is 7 or 13.

Other examples of useful nonionic surfactants include those having a formula RO(CH₂CH₂O)ₙH wherein R is a mixture of linear, even carbon-number hydrocarbon chains ranging from C₁₂H₂₅ to C₁₆H₃₃ and n represents the number of repeating units and is a number of from about 1 to about 12. Surfactants of this formula are presently marketed under the Genapol® tradename. available from Clariant, Charlotte, N.C., include the 26-L series of the general formula RO(CH₂CH₂O)ₙH wherein R is a mixture of linear, even carbon-number hydrocarbon chains ranging from C₁₂H₂₅ to C₁₆H₃₃ and n represents the number of repeating units and is a number of from 1 to about 12, such as 26-L-1,26-L-1,6,26-L-2,26-L-3,26-L-5,26-L-45,26-L-50,26-L-60,26-L-60N, 26-L-75, 26-L-80,26-L-98N, and the 24-L series, derived from synthetic sources and typically contain about 55% C₁₂ and 45% C₁₄ alcohols, such as 24-L-3,24-L-45,24-L-50,24-L-60, 24-L-60N, 24-L-75,24-L-92, and 24-L-98N. From product literature, the single number following the “L” corresponds to the average degree of ethoxylation (numbers between 1 and 5) and the two digit number following the letter “L” corresponds to the cloud point in ° C. of a 1.0 wt. % solution in water.

A further class of nonionic surfactants which are contemplated to be useful include those based on alkoxy block copolymers, and in particular, compounds based on ethoxy/propoxy block copolymers. Polymeric alkylene oxide block copolymers include nonionic surfactants in which the major portion of the molecule is made up of block polymeric C₂-C₄ alkylene oxides. Such nonionic surfactants, while preferably built up from an alkylene oxide chain starting group, and can have as a starting nucleus almost any active hydrogen containing group including, without limitation, amides, phenols, thiols and secondary alcohols.

One group of such useful nonionic surfactants containing the characteristic alkylene oxide blocks are those which may be generally represented by the formula (A):

HO-(EO)ₓ(PO)_{y}(EO)_{z}—H (A)

where
EO represents ethylene oxide,
PO represents propylene oxide,
y equals at least 15,

(EO)_{x+y} equals 20 to 50% of the total weight of said compounds, and, the total molecular weight is preferably in the range of about 2000 to 15,000. These surfactants are available under the PLURONIC tradename from BASF or Emulgen from Kao.

Another group of nonionic surfactants appropriate for use in the new compositions can be represented by the formula (B):

R-(EO, PO)ₐ(EO, PO)_{b}—H (B)

wherein R is an alkyl, aryl or aralkyl group, where the R group contains 1 to 20 carbon atoms, the weight percent of EO is within the range of 0 to 45% in one of the blocks a, b, and within the range of 60 to 100% in the other of the blocks a, b, and the total number of moles of combined EO and PO is in the range of 6 to 125 moles, with 1 to 50 moles in the PO rich block and 5 to 100 moles in the EO rich block.

Further nonionic surfactants which in general are encompassed by Formula B include butoxy derivatives of propylene oxide/ethylene oxide block polymers having molecular weights within the range of about 2000-5000.

Still further useful nonionic surfactants containing polymeric butoxy (BO) groups can be represented by formula (C) as follows:

RO—(BO)ₙ(EO)ₓ—H (C)

wherein
R is an alkyl group containing I to 20 carbon atoms,
n is about 5-15 and x is about 5-15.

Also useful as the nonionic block copolymer surfactants, which also include polymeric butoxy groups, are those which may be represented by the following formula (D):

HO-(EO)ₓ(BO)ₙ(EO)_{y}—H (D)

wherein
n is about 5-15, preferably about 15,
x is about 5-15, preferably about 15, and
y is about 5-15, preferably about 15.

Still further useful nonionic block copolymer surfactants include ethoxylated derivatives of propoxylated ethylene diamine, which may be represented by the following formula:

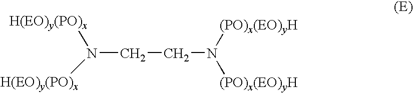

where
(EO) represents ethoxy,
(PO) represents propoxy,
   the amount of (PO)ₓ is such as to provide a molecular weight prior to ethoxylation of about 300 to 7500, and the amount of (EO)_{y} is such as to provide about 20% to 90% of the total weight of said compound.

By way of non-limiting example exemplary amphoteric surfactants which are contemplated to be useful in inventive compositions include one or more water-soluble betaine surfactants which may be represented by the general formula:

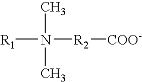

wherein R₁ is an alkyl group containing from 8 to 18 carbon atoms, or the amido radical which may be represented by the following general formula:

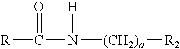

wherein R is an alkyl group having from 8 to 18 carbon atoms, a is an integer having a value of from 1 to 4 inclusive, and R₂ is a C₁-C₄ alkylene group. Examples of such water-soluble betaine surfactants include dodecyl dimethyl betaine, as well as cocoamidopropylbetaine.

Further useful surfactants include sarcosinate surfactants which are alkali metal salts of N-alkyl-N-acyl amino acids. These are salts derived from the reaction of (1) N-alkyl substituted amino acids of the formula:

R₁—NH—CH₂—COOH

where R₁ is a linear or branched chain lower alkyl of from 1 to 4 carbon atoms, especially a methyl, for example, aminoacetic acids such as N-methylaminoacetic acid (i.e. N-methyl glycine or sarcosine), N-ethyl-aminoacetic acid, N-butylaminoacetic acid, etc., with (2) saturated natural or synthetic fatty acids having from 8 to 18 carbon atoms, especially from 10 to 14 carbon atoms, e.g. lauric acid, and the like.

The resultant reaction products are salts which may have the formula:

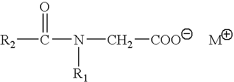

where M is an alkali metal ion such as sodium, potassium or lithium; R₁ is as defined above; and wherein R₂ represents a hydrocarbon chain, preferably a saturated hydrocarbon chain, having from 7 to 17 carbon atoms, especially 9 to 13 carbon atoms of the fatty acyl group

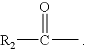

Exemplary useful sarcosinate surfactants include cocoyl sarcosinate, lauroyl sarcosinate, myristoyl sarcosinate, palmitoyl sarcosinate, stearoyl sarcosinate and oleoyl sarcosinate, and tallow sarcosinate. Such materials are also referred to as N-acyl sarcosinates.

A further useful class of surfactants are alkylpolyglucosides which are to be understood as including alkylmonoglucosides and alkylpolyglucosides surfactant based on a polysaccharide, which are preferably one or more alkyl polyglucosides. These materials may also be referred to as alkyl monoglucosides and alkylpolyglucosides. Suitable alkyl polyglucosides are known nonionic surfactants which are alkaline and electrolyte stable. Such include alkyl glucosides, alkyl polyglucosides and mixtures thereof. Alkyl glucosides and alkyl polyglucosides can be broadly defined as condensation articles of long chain alcohols, e.g., C₈-C₃₀ alcohols, with sugars or starches or sugar or starch polymers i.e., glucosides or polyglucosides. These compounds can be represented by the formula (S)ₙ—O—R wherein S is a sugar moiety such as glucose, fructose, mannose, and galactose; n is an integer of from about 1 to about 1000, and R is a C₈₋₃₀ alkyl group. Examples of long chain alcohols from which the alkyl group can be derived include decyl alcohol, cetyl alcohol, stearyl alcohol, lauryl alcohol, myristyl alcohol, oleyl alcohol and the like.

Alkyl mono- and polyglucosides are prepared generally by reacting a monosaccharide, or a compound hydrolyzable to a monosaccharide with an alcohol such as a fatty alcohol in an acid medium. Various glucoside and polyglucoside compounds including alkoxylated glucosides and processes for making them are disclosed in U.S. Pat. No. 2,974,134; U.S. Pat. No. 3,219,656; U.S. Pat. No. 3,598,865; U.S. Pat. No. 3,640,998; U.S. Pat. No. 3,707,535; U.S. Pat. No. 3,772,269; U.S. Pat. No. 3,839,318; U.S. Pat. No. 3,974,138; U.S. Pat. No. 4,223,129; and U.S. Pat. No. 4,528,106.

Exemplary useful alkyl glucoside surfactants suitable for use in the practice of this invention may be represented by formula I below:

RO—(R₁O)_{y}-(G)ₓZ_{b} I

wherein:
R is a monovalent organic radical containing from about 6 to about 30, preferably from about 8 to about 18 carbon atoms;
R₁ is a divalent hydrocarbon radical containing from about 2 to about 4 carbon atoms;
O is an oxygen atom;
y is a number which has an average value from about 0 to about 1 and is preferably 0;
G is a moiety derived from a reducing saccharide containing 5 or 6 carbon atoms; and
x is a number having an average value from about 1 to 5 (preferably from 1.1 to 2);
Z is O₂M¹,

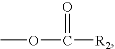

O(CH₂), CO₂M¹, OSO₃M¹, or O(CH₂)SO₃M¹; R₂ is (CH₂)CO₂M¹ or CH═CHCO₂M¹; (with the proviso that Z can be O₂M¹ only if Z is in place of a primary hydroxyl group in which the primary hydroxyl-bearing carbon atom,
—CH₂OH, is oxidized to form a

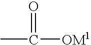

group);
b is a number of from 0 to 3x+1 preferably an average of from 0.5 to 2 per glycosal group;
p is 1 to 10,
M¹ is H⁺ or an organic or inorganic cation, such as, for example, an alkali metal, ammonium, monoethanolamine, or calcium.

As defined in Formula I above, R is generally the residue of a fatty alcohol having from about 8 to 30 and preferably 8 to 18 carbon atoms.

Further exemplary useful alkylpolyglucosides include those according to the formula II:

R₂O—(CₙH₂ₙO)ᵣ—(Z)ₓ II

wherein:

R₂ is a hydrophobic group selected from alkyl groups, alkylphenyl groups, hydroxyalkylphenyl groups as well as mixtures thereof, wherein the alkyl groups may be straight chained or branched, and which contain from about 8 to about 18 carbon atoms,

n has a value of 2-8, especially a value of 2 or 3; r is an integer from 0 to 10, but is preferably 0,

Z is derived from glucose; and,

x is a value from about 1 to 8, preferably from about 1.5 to 5.

Preferably the alkylpolyglucosides are nonionic fatty alkylpolyglucosides which contain a straight chain or branched chain C₈-C₁₅ alkyl group, and have an average of from about 1 to 5 glucose units per fatty alkylpolyglucoside molecule. More preferably, the nonionic fatty alkylpolyglucosides which contain straight chain or branched C₈-C₁₅ alkyl group, and have an average of from about 1 to about 2 glucose units per fatty alkylpolyglucoside molecule.

Examples of such alkylpolyglucosides as described above include, for example, APG™ 325 which is described as being a C₉-C₁₁ alkyl polyglucoside, also commonly referred to as D-glucopyranoside, (ex. Cognis). Further exemplary alkylpolyglucosides include Glucopon® 625 CS which is described as being a C₁₀-C₁₆ alkyl polyglucoside, also commonly referred to as a D-glucopyranoside, (ex. Cognis), lauryl polyglucoside available as APG™ 600 CS and 625 CS (ex. Cognis) as well as other materials sold under the Glucopon® tradename, e.g., Glucopon® 215, Glucopon® 225, Glucopon® 425, especially one or more of the alkyl polyglucosides demonstrated in one or more of the examples. It is believed that the alkylpolyglucoside surfactants sold under the Glucopon® tradename are synthezied at least in part on synthetically produced starting constituents and are colorless or only slightly colored, while those sold under the APG™ are synthesized at least in part on naturally occurring or sourced starting constituents and are more colored in appearance.

In preferred embodiments of the invention, the first aqueous composition comprises a nonionic surfactant, especially one or more amine oxide compounds which provide a cleaning benefit to treated hard surfaces. Exemplary useful amine oxide compounds include one or more which may be described in one or more of the following of the four general classes:

(1) Alkyl di (lower alkyl) amine oxides in which the alkyl group has about 6-24, and preferably 8-18 carbon atoms, and can be straight or branched chain, saturated or unsaturated. The lower alkyl groups include between 1 and 7 carbon atoms, but preferably each include 1-3 carbon atoms. Examples include octyl dimethyl amine oxide, lauryl dimethyl amine oxide, myristyl dimethyl amine oxide, and those in which the alkyl group is a mixture of different amine oxides, such as dimethyl cocoamine oxide, dimethyl (hydrogenated tallow) amine oxide, and myristyl/palmityl dimethyl amine oxide;

(2) Alkyl di (hydroxy lower alkyl) amine oxides in which the alkyl group has about 6-22, and preferably 8-18 carbon atoms, and can be straight or branched chain, saturated or unsaturated. Examples include bis-(2-hydroxyethyl) cocoamine oxide, bis-(2-hydroxyethyl) tallowamine oxide; and bis-(2-hydroxyethyl) stearylamine oxide;

(3) Alkylamidopropyl di(lower alkyl) amine oxides in which the alkyl group has about 10-20, and preferably 12-16 carbon atoms, and can be straight or branched chain, saturated or unsaturated. Examples are cocoamidopropyl dimethyl amine oxide and tallowamidopropyl dimethyl amine oxide; and

(4) Alkylmorpholine oxides in which the alkyl group has about 10-20, and preferably 12-16 carbon atoms, and can be straight or branched chain, saturated or unsaturated.

While these amine oxides recited above may be used, preferred are amine oxides which may be represented by the following structural representation:

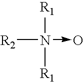

wherein
each R₁ independently is a straight chained C₁-C₄ alkyl group; and,
R₂ is a straight chained C₆-C₂₂ alkyl group or an alkylamidoalkylene having the formula

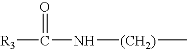

where R₃ is C₅-C₂₀ alkyl or

—(CH₂)ₚ—OH
where n is 1 to 5 and p is 1 to 6; additionally, R₂ or R₃ could be ethoxylated (e.g., 1 to 10 moles EO/mol) or propoxylated (e.g., 1 to 10 moles of PO/mol).

Each of the alkyl groups may be linear or branched, but most preferably are linear. Examples include particularly preferred amine oxides include lauryl dimethyl amine oxide, cocoamidopropylamine oxide, and myristyldimethylamine oxide. Lauryl dimethyl amine oxide is particularly preferred.

When present the amine oxide surfactant constituent desirably forms 0.05-5% wt., preferably 0.1-2% wt., and most preferably 0.1-1% wt. of the first aqueous composition.

When present, any surfactant(s) may be present in the hard surface treatment composition in any cleaning effective amounts. Advantageously any surfactants present are present in amounts of from 0.0001-10% wt, preferably from 0.01-5% wt., yet more preferably from 0.05-4% wt. based on the total weight of the hard surface treatment composition, formed from a mixture of the first aqueous composition and the second aqueous composition, of which they form a part.

Any surfactants, when present in the inventive compositions, may be included in either the first aqueous composition or second aqueous composition or both, it being required only that the selected surfactants provide cleaning effectiveness when the hard surface treatment compositions taught herein are formed, and that they are relatively stable within the respective first aqueous composition and second aqueous composition of which they form a part.

According to certain preferred embodiments of the invention, anionic surfactants are excluded.

According to certain preferred embodiments of the invention, cationic surfactants are excluded.

According to certain preferred embodiments of the invention, amphoteric surfactants are excluded.

According to certain preferred embodiments of the invention, zwitterionic surfactants are excluded.

According to certain preferred embodiments of the invention, the sole surfactant present in the inventive compositions are nonionic surfactants, especially one or more amine oxide surfactants. In certain embodiments the sole surfactant present is one or more amine oxides.

According to certain further preferred embodiments, any surfactants present in the inventive compositions are present only within the first aqueous composition of the hard surface treatment compositions taught herein.

The hard surface treatment compositions of the invention may further include one or more organic solvents. By way of non-limiting example exemplary useful organic solvents which may be included in the inventive compositions include those which are at least partially water-miscible such as alcohols (e.g., low molecular weight alcohols, such as, for example, ethanol, propanol, isopropanol, and the like), glycols (such as, for example, ethylene glycol, propylene glycol, hexylene glycol, and the like), water-miscible ethers (e.g. diethylene glycol diethylether, diethylene glycol dimethylether, propylene glycol dimethylether), water-miscible glycol ether (e.g. propylene glycol monomethylether, propylene glycol mono ethylether, propylene glycol monopropylether, propylene glycol monobutylether, ethylene glycol monobutylether, dipropylene glycol monomethylether, diethyleneglycol monobutylether), lower esters of monoalkylethers of ethylene glycol or propylene glycol (e.g. propylene glycol monomethyl ether acetate), and mixtures thereof. Glycol ethers having the general structure Rₐ-R_{b}—OH, wherein Rₐ is an alkoxy of 1 to 20 carbon atoms, or aryloxy of at least 6 carbon atoms, and R_{b} is an ether condensate of propylene glycol and/or ethylene glycol having from one to ten glycol monomer units. Of course, mixtures of two or more organic solvents may be used in the organic solvent constituent.

When present, the organic solvent constituent is desirably present in an amount of from 0.01-10% wt., preferably in amounts of at least 0.05% wt., more preferably 0.1% wt., yet more preferably 0.25% wt. based on the total weight of the hard surface treatment composition formed from the mixture of first aqueous composition and second aqueous composition of which the organic solvent constituent forms a part. Desirably the organic solvent constituent is desirably present in an amount of not more than 10% wt., preferably not more than 7% wt., yet more preferably not more than 5% wt. based on the total weight of the hard surface treatment composition of which it forms a part. The one or more solvents may be present in the first aqueous composition, second aqueous composition or in both the first aqueous composition and second aqueous composition.

According to certain and preferred aspects of the invention, these one or more organic solvents are expressly excluded from the compositions.

The compositions may optionally include one or more one or more further constituents useful in improving one or more aesthetic and/or technical characteristics of the compositions. Exemplary further optional constituents include coloring agents, fragrances and fragrance solubilizers, viscosity modifiers such as thickeners, hydrotropes, pH adjusting agents and pH buffers including organic and inorganic salts, optical brighteners, opacifying agents, hydrotropes, as well as other optional constituents providing improved technical or aesthetic characteristics known to the relevant art. Any such further constituents may be present in the first aqueous composition or the second aqueous composition, it only being required that they their presence in the respective composition does not undesirably affect the composition of which they form a part.

When present, the total amount of such one or more optional constituents present in the inventive compositions do not exceed about 15% wt., preferably do not exceed about 10% wt., more preferably to not exceed 7.5% wt., yet more preferably do not exceed 5% wt., still more preferably do not exceed 2.5% wt., based on the total weight of the HST hard surface treatment composition of which they form a part.

By way of non-limiting example pH adjusting agents include phosphorus containing compounds, monovalent and polyvalent salts such as of silicates, carbonates, and borates, certain acids and bases, tartrates and certain acetates. Further exemplary pH adjusting agents include mineral acids, basic compositions, and organic acids, which are typically required in only minor amounts. By way of further non-limiting example pH buffering compositions include the alkali metal phosphates, polyphosphates, pyrophosphates, triphosphates, tetraphosphates, silicates, metasilicates, polysilicates, carbonates, hydroxides, and mixtures of the same. Certain salts, such as the alkaline earth phosphates, carbonates, hydroxides, can also function as buffers. It may also be suitable to use as buffers such materials as aluminosilicates (zeolites), borates, aluminates and certain organic materials such as gluconates, succinates, maleates, and their alkali metal salts. When present, the pH adjusting agent, especially the pH buffers are present in an amount effective in order to maintain the pH of the inventive composition within a target pH range.

The compositions of the invention optionally but in certain cases desirably include a fragrance constituent. Fragrance raw materials may be divided into three main groups: (1) the essential oils and products isolated from these oils; (2) products of animal origin; and (3) synthetic chemicals. Generally perfumes are complex mixtures or blends various organic compounds including, but not limited to, certain alcohols, aldehydes, ethers, aromatic compounds and varying amounts of essential oils such as from about 0 to about 85% by weight, usually from about 10 to about 70% by weight, the essential oils themselves being volatile odiferous compounds and also functioning to aid in the dissolution of the other components of the fragrance composition. Examples of such fragrances include digeranyl succinate, dineryl succinate, geranyl neryl succinate, geranyl phenylacetate, neryl phenylacetate, geranyl laurate, neryl laurate, di(b-citronellyl) maleate, dinonadol maleate, diphenoxyanol maleate, di(3,7-dimethyl-1-octanyl) succinate, di(cyclohexylethyl) maleate, diflralyl succinate, di(phenylethyl) adipate, 7-acetyl-1,2,3,4,5,6,7,8-octahydro-1,1,6,7-tetramethyl naphthalene, ionone methyl, ionone gamma methyl, methyl cedrylone, methyl dihydrojasmonate, methyl 1,6,10-trimethyl-2,5,9-cyclododecatrien-1-yl ketone, 7-acetyl-1,1,3,4,4,6-hexamethyl tetralin, 4-acetyl-6-tert-butyl-1-,1-dimethyl indane, para-hydroxy-phenyl-butanone, benzophenone, methyl beta-naphthyl ketone, 6-acetyl-1,1,2,3,3,5hexamethyl indane, 5-acetyl-3-isopropyl-1,1,2,6-tetramethyl indane, 1-dodecanal, 4-(4-hydroxy-4-methylpentyl)-3-cyclohexene-1-carboxaldehyde, 7-hydroxy-3,7-dimethyl ocatanal, 10-undecen-1-al, isohexenyl cyclohexyl carboxaldehyde, formyl tricyclodecane, condensation products of hydroxycitronellal and methyl anthranilate, condensation products of hydroxycitronellal and indol, condensation products of phenyl acetaldehyde and indol, 2-methyl-3-(para-tert-butylphenyl)-propionaldehyde, ethyl vanillin, heliotropin, hexyl cinnamic aldehyde, amyl cinnamic aldehyde, 2-methyl-2-(para-iso-propylphenyl)propionaldehyde, coumarin, decalactone gamma, cyclopentadecanolide, 16-hydroxy-9-hexadecenoic acid lactone, 1,3,4,6,7,8-hexahydro-4,6,6,7,8,8-hexamethylcyclopenta-gamma-2-b-enzopyrane, beta-naphthol methyl ether, ambroxane, dodecahydro-3a,6,6,9a-t-etramethylnaphtho[2,1b]furan, cedrol, 5-(2,2,3-trimethylcyclopent-3-enyl)-3-methylpentan-2-ol, 2-ethyl-4-(2,2,3-trimethyl-3-cyclopenten-1-yl)-2-bute-n-1-ol, caryophyllene alcohol, tricyclodecenyl propionate, tricyclodecenyl acetate, benzyl salicylate, cedryl acetate, para-(tert-butyl)cyclohexyl acetate, essential oils, resinoids, and resins from a variety of sources including but not limited to orange oil, lemon oil, patchouli, Peru balsam, Olibanum resinoid, styrax, labdanum resin, nutmeg, cassia oil, benzoin resin, coriander, lavandin, and lavender, phenyl ethyl alcohol, terpineol, linalool, linalyl acetate, geraniol, nerol, 2-(1,1-dimethylethyl)cyclohexanol acetate, benzyl acetate, orange terpenes, eugenol, diethylphthalate, and combinations thereof. In the present invention, the precise composition of the fragrance is of no particular consequence so long as it may be effectively included as a constituent of the compositions, and have a pleasing fragrance.

Fragrance compositions as received from a supplier may be provided as an aqueous or organically solvated composition, and may include as a hydrotrope or emulsifier a surface-active agent, typically a surfactant, in minor amount. Such fragrance compositions are quite usually proprietary blends of many different specific fragrance compounds. However, one of ordinary skill in the art, by routine experimentation, may easily determine whether such a proprietary fragrance composition is compatible in the compositions of the present invention.

One or more coloring agents may also be used in the inventive compositions in order to impart a desired colored appearance or colored tint to the compositions. Known art water soluble or water dispersible pigments and dyes may be added in effective amounts.

The inventive compositions may include one or more hydrotropes, particularly one or more hydrotropes based on sulfonated compounds. Organic hydrotropes useful in the use of the compositions of the present invention include known art hydrotrope compositions. Suitable hydrotropes include salts of aryl sulfonic acids such as naphtyl and benzene sulfonic acids, wherein the aromatic nucleus may be unsubstituted or substituted with lower alkyl groups, such as C₁₋₄ alkyl groups, especially methyl, ethyl and/or isopropyl groups. Up to three of such substitutents may be present in the aromatic nucleus, but preferably zero to two are preferred. The salt forming cation of the hydrotrope is preferably an alkali metal such as sodium or potassium, especially sodium. However, other water soluble cations such as ammonium, mono-, di- and tri-lower alkyl, i.e., C₁₋₄ alkanol ammonium groups can be used in the place of the alkali metal cations. Exemplary hydrotropes include benzene sulfonates, o-toluene sulfonates, m-toluene sulfonates, and p-toluene sulfonates; 2,3-xylene sulfonates, 2,4-xylene sulfonates, and 4,6-xylene sulfonates; cumene sulfonates, toluene sulfonates, wherein such exemplary hydrotropes are generally in a salt form thereof, including sodium and potassium salt forms. Further exemplary hydrotropes include lower alkyl sulfate salts, particularly those having from about one to six carbon atoms in the alkyl group.

When present, the hydrotrope constituent is desirably present in an amount of from 0.01-5% wt. based on the total weight of the composition.

According to certain and preferred aspects of the invention, these one or more hydrotropes are expressly excluded from the compositions.

The first aqueous composition may comprise one or more preservatives. Such preservatives are primarily included to reduce the growth of undesired microorganisms within the composition during storage prior to use. Exemplary useful preservatives include compositions which include parabens, including methyl parabens and ethyl parabens, glutaraldehyde, formaldehyde, 2-bromo-2-nitropropoane-1,3-diol, 5-chloro-2-methyl-4-isothiazolin-3-one, 2-methyl-4-isothiazoline-3-one, and mixtures thereof. One exemplary composition is a combination 5-chloro-2-methyl-4-isothiazolin-3-one and 2-methyl-4-isothiazolin-3-one where the amount of either component may be present in the mixture anywhere from 0.001 to 99.99 weight percent, based on the total amount of the preservative. Further exemplary useful preservatives include those which are commercially including a mixture of 5-chloro-2-methyl-4-isothiazolin-3-one and 2-methyl-4-isothiazolin-3-one marketed under the trademark KATHON® CG/ICP as a preservative composition presently commercially available from Rohm and Haas (Philadelphia, Pa.). Further useful and commercially available preservative compositions include KATHON® CG/ICP II, a further preservative composition presently commercially available from Rohm and Haas (Philadelphia, Pa.), PROXEL® which is presently commercially available from Zeneca Biocides (Wilmington, Del.), SUTTOCIDE® A which is presently commercially available from Sutton Laboratories (Chatam, N.J.) as well as TEXTAMER® 38AD which is presently commercially available from Calgon Corp. (Pittsburgh, Pa.).

Optionally one or more abrasives may be included in the inventive compositions. Exemplary abrasives include: oxides, e.g., calcined aluminum oxides and the like, carbonates, e.g., calcium carbonate and the like, quartzes, siliceous chalk, diatomaceous earth, colloidal silicon dioxide, alkali metasilicates, e.g., sodium metasilicate and the like, perlite, pumice, feldspar, calcium phosphate, organic abrasive materials based on comminuted or particulate polymers especially one or more of polyolefins, polyethylenes, polypropylenes, polyesters, polystyrenes, acetonitrile-butadiene-styrene resins, melamines, polycarbonates, phenolic resins, epoxies and polyurethanes, natural materials such as, for example, rice hulls, corn cobs, and the like, or talc and mixtures thereof. The particle size of the abrasive agent typically may range from about 1 μm to about 1000 μm, preferably between about 10 μm to about 200 μm, and more preferably between about 10 μm and about 100 μm. It is preferred to us those abrasive agents that will not scratch most hard surfaces. Such abrasive agents include calcium carbonate, siliceous chalk, diatomaceous earth, colloidal silicon dioxide, sodium metasilicate, talc, and organic abrasive materials. Calcium carbonate is preferred as being effective and available at a generally low cost. A single type of abrasive, or a mixture of two or more differing abrasive materials may be used.

Optionally the compositions may include an effective amount of at least one inorganic chloride salt, which are believed to improve the metal cleaning characteristics of the inventive compositions. The inorganic chloride salt is desirably present in an amount effective to provide improved cleaning of metal surfaces which are immersed or contacted with the inventive compositions. The inorganic chloride salt(s) used in the compositions of the present invention can be any water-soluble inorganic chloride salt or mixtures of such salts. For purposes of the present invention, “water-soluble” means having a solubility in water of at least 10 grams per hundred grams of water at 20° C. Examples of suitable salts include various alkali metal and/or alkaline earth metal chlorides including sodium chloride, calcium chloride, magnesium chloride and zinc chloride. Particularly preferred are sodium chloride and calcium chloride which have been surprisingly observed to provide excellent metal cleaning efficacy particularly of aged copper surfaces. The inorganic chloride salt(s) is present in the compositions of the present invention in an amount which will provide an improved cleaning of metal surfaces, particularly copper surfaces, compared to an identical composition which excludes the inorganic chloride salts(s). Preferably, when present, the inorganic chloride salt(s) are present in amounts of from about 0.00001 to about 2.5% by weight, desirably in amounts of 0.001 to about 2% by weight, yet more desirably from about 0.01 to about 1.5% by weight and most desirably from about 0.2 to about 1.5% weight based on the total weight of the hard surface treatment composition. In certain preferred embodiments the sole inorganic salts present are one or more inorganic chloride salts, most preferably sodium chloride.

In certain preferred embodiments the treatment compositions are viscous, and exhibit a viscosity of at least about 500 cps at 20° C. Compositions of the invention which are viscous may include a thickener constituent which is effective in increasing the viscosity of the compositions. Viscous compositions according to the invention frequently exhibit a tendency to partially cling to inclined or vertical surfaces, e.g., bathroom bathtub enclosures, shower stalls, sinks or toilet, and the like.

The inventive compositions may additionally include a thickener constituent which may be added in any effective amount in order to increase the viscosity of the compositions. Exemplary thickeners useful in the thickener constituent include one or more of polysaccharide polymers selected from cellulose, alkyl celluloses, alkoxy celluloses, hydroxy alkyl celluloses, alkyl hydroxy alkyl celluloses, carboxy alkyl celluloses, carboxy alkyl hydroxy alkyl celluloses, naturally occurring polysaccharide polymers such as xanthan gum, guar gum, locust bean gum, tragacanth gum, or derivatives thereof, polycarboxylate polymers, polyacrylamides, clays, and mixtures thereof.

Examples of the cellulose derivatives include methyl cellulose ethyl cellulose, hydroxymethyl cellulose hydroxy ethyl cellulose, hydroxy propyl cellulose, carboxy methyl cellulose, carboxy methyl hydroxyethyl cellulose, hydroxypropyl cellulose, hydroxy propyl methyl cellulose, ethylhydroxymethyl cellulose and ethyl hydroxy ethyl cellulose.

Exemplary polycarboxylate polymers thickeners have a molecular weight from about 500,000 to about 4,000,000, preferably from about 1,000,000 to about 4,000,000, with, preferably, from about 0.5% to about 4% crosslinking. Preferred polycarboxylate polymers include polyacrylate polymers including those sold under trade names Carbopol®, Acrysol® ICS-1 and Sokalan®. The preferred polymers are polyacrylates. Other monomers besides acrylic acid can be used to form these polymers including such monomers as ethylene and propylene which act as diluents, and maleic anhydride which acts as a source of additional carboxylic groups.

Exemplary clay thickeners comprise, for example, colloid-forming clays, for example, such as smectite and attapulgite types of clay thickeners. The clay materials can be described as expandable layered clays, i.e., aluminosilicates and magnesium silicates. The term “expandable” as used to describe the instant clays relates to the ability of the layered clay structure to be swollen, or expanded, on contact with water. The expandable clays used herein are those materials classified geologically as smectites (or montmorillonite) and attapulgites (or polygorskites).

Preferred thickeners are those which provide a useful viscosity increasing benefit at the ultimate pH of the compositions, particularly thickeners which are useful at pH's of 10 or more, preferably 11 or more, and most preferably 12 or more.

In certain preferred embodiments, viscous compositions of the invention are viscous and exhibit a viscosity of at least about 500 cps at room temperature (approximately 20° C.) as measured using a Brookfield RVT viscometer, a type 2 spindle operating at 20 rpm. Preferably the hard surface treatment compositions exhibit viscosities in the range of at least about 600 cps, preferably at least about 1000 cps as measured under these conditions. Preferably the hard surface treatment compositions exhibit viscosities in the range of at about 5000 cps or less, preferably about 3000 cps or less and most preferably about 2500 cps or less.

As is noted above, the first aqueous composition, second aqueous composition and the hard surface treatment composition according to the invention are largely aqueous in nature and are fluid liquids, which may be poured or sprayed. Water is added to order to provide to 100% by weight of the compositions of the invention. The water may be tap water, but is preferably distilled or ‘soft’ water, viz., demineralized water and is most preferably deionized water. If the water is tap water, it is preferably substantially free of any undesirable impurities such as organics or inorganics, especially minerals salts which are present in hard water which may thus undesirably interfere with the operation of the constituents present in the aqueous compositions according to the invention. Preferably at least 70% wt, more preferably at least 75% wt of the hard surface treatment compositions are water and in increasing order of preference: 73% wt., 74% wt., 75% wt., 76% wt., 77% wt., 78% wt., 79% wt., 80% wt., 81% wt., 82% wt., 83% wt., 84% wt., 85% wt., 86% wt., 87% wt., 88% wt., 89% wt., 90% wt., 91% wt., and 92% wt are water.

While the first aqueous composition and the second aqueous composition may be mixed at any time prior to their use and application onto a surface wherein the presence of mold and/or mold spores and/or fungi are known or suspected, advantageously they are admixed not more than 3 minutes, preferably within 90 seconds, yet more preferably within about 20 seconds, still more preferably within about 10 seconds, and most preferably within about 3 seconds before being applied to a hard surface requiring treatment. The said first and second aqueous compositions may be mixed in any suitable proportions, depending upon their initial concentrations to form the treatment composition. Preferably the treatment composition formed from the mixture of the first aqueous composition and the second aqueous composition comprises from about 0.001 to about 10% w/w, preferably 0.001-5% wt. of active chlorine, and simultaneously 0.001 to about 5% w/w, preferably 0.001-3% wt. of the fungicide. Preferably, the volumetric ratio or weight ratios of the first aqueous composition to the second aqueous composition which are mixed, interchangeably referred to as the “mixing ratio” is from 10:1 to 1:10, yet more preferably a ratio in the range of from 2:1 to 1:2, still more preferably in a ratio of from 1.5:1 to 1:1.5, and most preferably the mixing ratio of the first aqueous composition to the second aqueous composition are approximately 1:1, namely they are mixed in substantially equal parts.

The resultant hard surface treatment composition formed by the admixture of the first aqueous composition and second aqueous composition described herein preferably exhibits a pH in the range of 12 to 15, and more preferably a pH in the range of 12.5 to 13.5.

The hard surface treatment compositions of the invention may be stored prior to use and in any of a variety of known art containers, it being required only that the first and second aqueous compositions remain isolated from one another during storage until shortly prior to, or upon use in the treatment of hard surfaces. Preferably each of first and second aqueous compositions are separately stored from and dispensed from separate containers in two-compartment dispenser which is adapted to dispense each of said compositions onto a surface, either sequentially or, preferably, simultaneously. For example, exemplary two-compartment dispensers include those disclosed in U.S. Pat. No. 3,760,986; U.S. Pat. No. 5,152,461; U.S. Pat. No. 5,332,157; U.S. Pat. No. 5,439,141; U.S. Pat. No. 5,560,545; U.S. Pat. No. 5,562,250; U.S. Pat. No. 5,626,259; U.S. Pat. No. 5,887,761; U.S. Pat. No. 5,964,377; U.S. Pat. No. 5,472,119; U.S. Pat. No. 5,385,270; U.S. Pat. No. 5,009,342; U.S. Pat. No. 4,902,281; U.S. Pat. No. 4,826,048; U.S. Pat. No. 5,339,990; U.S. Pat. No. 4,949,874, U.S. Pat. No. 5,562,250; U.S. Pat. No. 4,355,739; U.S. Pat. No. 3,786,963; U.S. Pat. No. 5,934,515; U.S. Pat. No. 3,729,553; U.S. Pat. No. 5,154,917; U.S. Pat. No. 5,289,950; U.S. Pat. No. 5,252,312; CA2306283; EP875460; EP979782; EP479-451; and WO9505327, the contents of which are herein incorporated by reference thereto.

The compositions of the invention may be packaged in any suitable container which keeps the first aqueous composition and the second aqueous composition separate during storage, e.g, a non-pressurized container such as a rigid bottle having separate chambers, a manually squeezable bottle (deformable bottle), as well as in a spray bottle which uses a dip tube and trigger assembly to dispense a liquid, also widely known as a pump-spray apparatus. Advantageously the compositions of the invention are provided in a non-pressurized dual-chamber bottle which includes either a mixing nozzle which causes the mixing of the first aqueous composition and the second aqueous composition immediately following their dispensation from separate chambers, or in a non-pressurized dual-chamber bottle which includes a pump-spray apparatus for simultaneously delivering measured quantities of both the first aqueous composition and the second aqueous composition from their respective chambers and causes the dispensed first aqueous composition and second aqueous composition to be mixed when exiting the pump-spray apparatus. Preferably the pump-spray apparatus simultaneously meters the respective first aqueous composition and second aqueous composition being dispensed from their respective chambers. Conveniently the pump-spray apparatus may be manually operated by a user or consumer such as a trigger-spray apparatus. In use, the user of the inventive composition dispenses a quantity of the composition and applied it to the surface needing treatment The inventive compositions are desirably provided as a ready-to-use product which may be directly applied to a hard surface or other substrate upon which mold may be present. Advantageously the hard surface treatment compositions are useful in the treating of hard surfaces wherein the presence of mold and/or mold spores and/or fungi are known or suspected. Preferred embodiments of the invention provide both an initial benefit as well as a more durable benefit wherein hard surfaces treated with the said inventive compositions exhibit provide improved mold and/or fungi remediation properties. By way of example, hard surfaces suitable for treating with the hard surface treatment composition include surfaces composed of refractory materials such as: glazed and unglazed tile, brick, porcelain, ceramics as well as stone including marble, granite, and other stones surfaces; glass; metals; plastics e.g. polyester, vinyl; fiberglass, Formica®, Corian® and other hard surfaces known to the industry. Further hard surfaces which are to be denoted are those associated with kitchen environments and other environments associated with food preparation, including cabinets and countertop surfaces as well as walls and floor surfaces especially those which include refractory materials, plastics, Formica®, Corian® and stone. Still further hard surfaces include those associated with medical facilities, e.g., hospitals, clinics as well as laboratories, e.g., medical testing laboratories.

The hard surface treatment composition of the invention is particularly useful in the treatment of lavatory surfaces, e.g., lavatory fixtures such as shower stalls, bathtubs and bathing appliances (racks, curtains, shower doors, shower bars) toilets, bidets, wall and flooring surfaces (including painted surfaces) especially those which include refractory materials including tiled and grouted surfaces and the like wherein mold and/or fungi is likely to live. Moist humid environments such as lavatories, particularly bathtubs, bathtub enclosures and shower stalls are prone to provide suitable living conditions for undesired mold and/or fungi. Further lavatory hard surfaces, e.g., grouted tiled surfaces, are particularly relevant substrates as they often harbor undesired mold and/or fungi due to the relatively high amount of moisture, as well as also typically elevated ambient environmental temperatures found in lavatories. Thus the inventive compositions are particularly suited for the treatment of lavatory surfaces, particularly the aforesaid lavatory surfaces.

The hard surface treatment compositions according to the invention are also useful in the removal of greasy soils from hard surfaces, such kitchen surfaces, flooring surfaces, tile surfaces and the like.

According to certain particularly preferred embodiments of the invention, the resultant hard surface treatment composition which is formed by the admixture of two aqueous compositions also provides in addition to a useful cleaning benefit, a sanitizing or disinfecting benefit as well. Such particularly preferred embodiments demonstrate antimicrobial efficacy against one or more microorganisms selected from: S. aureus, E. coli, Ps. aeruginosa, and E. hirae.

Particularly preferred embodiments of the inventive compositions also exhibit good storage stability.

Further optional constituents, although not particularly elucidated herein may also be included in effective amounts as may be deemed appropriate or necessary.

The following examples below illustrate exemplary formulations and certain particularly preferred formulations of the inventive composition. It is to be understood that these examples are presented by means of illustration only and that further useful formulations fall within the scope of this invention and the claims may be readily produced by one skilled in the art and not deviate from the scope and spirit of the invention. Throughout this specification and in the accompanying claims, weight percents of any constituent are to be understood as the weight percent of the active portion of the referenced constituent, unless otherwise indicated.

### EXAMPLES

Examples of inventive formulations are shown in the following table; unless otherwise stated, the components indicated are provided as “100% active” unless otherwise stated on Table 1 or Table 2. The amounts of the named constituents are indicated in % w/w based on a total weight of either the respective individual first aqueous composition or the second aqueous composition. Deionized water was added in “quantum sufficient” (“q.s.”) to each of first aqueous composition and second aqueous composition so to provide the balance to 100 parts by weight of each.

The compositions of the first aqueous composition and second aqueous composition as indicated on the following Table 1 were separately produced by providing measured amounts of the individual constituent to a proportion of the water present in each individual component under stirring and at room temperature. The second aqueous composition and first aqueous composition were produced separately.

### Example 1

The compositions of each of first aqueous composition and second aqueous composition as indicated on the following table were separately produced by providing measured amounts of the individual to a proportion of the water present in each individual component under stirring and at room temperature.

Example 1

| | | second |
|---|---|---|
| | first aqueous | aqueous |
| | composition | composition |
| | (% wt.) | (% wt.) |
| sodium hypochlorite (13%) | 38.46 | — |
| sodium hydroxide (25%) | 1.6 | — |
| sodium chloride | 2.0 | — |
| lauryl dimethyl amine oxide (30%) | 2.0 | — |
| fragrance | 0.10 | — |
| d.i. water | q.s. | — |
| potassium salt of cyclohexyl hydroxyl | — | 2.0 |
| diazenium-1-oxide (30%) | | |
| d.i. water | — | q.s. |
| pH | 13.68 | 8.36 |

| | |
|---|---|
| pH of mixture | 13.41 |

Thereafter for the foregoing, equal amounts of first aqueous composition and second aqueous composition were supplied to separate portions of a dual-chamber bottle formed of a flexible thermoplastic material, and which was further provided with a pump-spray apparatus which was manually operated by a trigger and ensured both the delivery of approximately equal amounts of the first aqueous composition and second aqueous composition with each pump stroke, and ensure mixing of the first aqueous composition with the second aqueous composition after leaving the respective individual nozzles used to dispense the said compositions thus forming the hard surface treatment composition.

### Example 2

The compositions of each of first aqueous composition and second aqueous composition as indicated on the following table were separately produced by providing measured amounts of the individual to a proportion of the water present in each individual component under stirring and at room temperature.

Example 2A

| | | second |
|---|---|---|
| | first aqueous | aqueous |
| | composition | composition |
| | (% wt.) | (% wt.) |
| sodium hypochlorite (13%) | 38.46 | — |
| sodium hydroxide (25%) | 1.6 | — |
| sodium chloride | 2.0 | — |
| lauryl dimethyl amine oxide (30%) | 2.0 | — |
| fragrance | 0.10 | — |
| d.i. water | q.s. | — |
| potassium salt of cyclohexyl hydroxyl | — | 2.0 |
| diazenium-1-oxide (30%) | | |
| silane (40%) | — | 8.0 |
| d.i. water | — | q.s. |
| pH | 13.68 | 7.92 |

| | |
|---|---|
| pH of mixture | 13.48 |

Example 2B

| | | second |
|---|---|---|
| | first aqueous | aqueous |
| | composition | composition |
| | (% wt.) | (% wt.) |
| sodium hypochlorite (13%) | 38.46 | — |
| sodium hydroxide (25%) | 1.6 | — |
| sodium chloride | 2.0 | — |
| lauryl dimethyl amine oxide (30%) | 2.0 | — |
| fragrance | 0.10 | — |
| d.i. water | q.s. | — |
| potassium salt of cyclohexyl hydroxyl | — | 2.0 |
| diazenium-1-oxide (30%) | | |
| silane (40%) | — | 4.0 |
| d.i. water | — | q.s. |
| pH | 13.68 | 8.00 |

| | |
|---|---|
| pH of mixture | 13.50 |

Example 2C

| | | second |
|---|---|---|
| | first aqueous | aqueous |
| | composition | composition |
| | (% wt.) | (% wt.) |
| sodium hypochlorite (13%) | 38.46 | — |
| sodium hydroxide (25%) | 1.6 | — |
| sodium chloride | 2.0 | — |
| lauryl dimethyl amine oxide (30%) | 2.0 | — |
| fragrance | 0.10 | — |
| d.i. water | q.s. | — |
| potassium salt of cyclohexyl hydroxyl | — | 2.0 |
| diazenium-1-oxide (30%) | | |
| silane (40%) | — | 1.6 |
| d.i. water | — | q.s. |
| pH | 13.68 | 8.38 |

| | |
|---|---|
| pH of mixture | 13.44 |

Example 2D

| | | second |
|---|---|---|
| | first aqueous | aqueous |
| | composition | composition |
| | (% wt.) | (% wt.) |
| sodium hypochlorite (13%) | 23.07 | — |
| sodium hydroxide (25%) | 1.6 | — |
| sodium chloride | 2.0 | — |
| lauryl dimethyl amine oxide (30%) | 2.0 | — |
| fragrance | 0.10 | — |
| d.i. water | q.s. | — |
| potassium salt of cyclohexyl hydroxyl | — | 2.0 |
| diazenium-1-oxide (30%) | | |
| silane (40%) | — | 1.6 |
| d.i. water | — | q.s. |
| pH | 13.2 | 8.38 |

| | |
|---|---|
| pH of mixture | 13.24 |

Example 2E

| | | second |
|---|---|---|
| | first aqueous | aqueous |
| | composition | composition |
| | (% wt.) | (% wt.) |
| sodium hypochlorite (13%) | 23.07 | — |
| sodium hydroxide (25%) | 1.6 | — |
| sodium chloride | 2.0 | — |
| lauryl dimethyl amine oxide (30%) | 2.0 | — |
| fragrance | 0.10 | — |
| d.i. water | q.s. | — |
| potassium salt of cyclohexyl hydroxyl | — | 2.0 |
| diazenium-1-oxide (30%) | | |
| silane (40%) | — | 8.0 |
| d.i. water | — | q.s. |
| pH | 13.24 | 7.92 |

| | |
|---|---|
| pH of mixture | 13.24 |

Thereafter for each of the foregoing, equal amounts of first aqueous composition and second aqueous composition were supplied to separate portions of a dual-chamber bottle formed of a flexible thermoplastic material, and which was further provided with a pump-spray apparatus which was manually operated by a trigger and ensured both the delivery of approximately equal amounts of the first aqueous composition and second aqueous composition with each pump stroke, and ensure mixing of the first aqueous composition with the second aqueous composition after leaving the respective individual nozzles used to dispense the said compositions thus forming the hard surface treatment composition.

### Example 3

A further composition according to the invention was formed by providing measured amounts of the individual constituents on the following table in the manner described with reference to Example 1.

Example 3A

| | | second |
|---|---|---|
| | first aqueous | aqueous |
| | composition | composition |
| | (% wt.) | (% wt.) |
| sodium hypochlorite (13%) | 38.46 | — |
| sodium hydroxide (25%) | 1.6 | — |
| sodium chloride | 2.0 | — |
| lauryl dimethyl amine oxide (30% | 2.0 | — |
| active) | | |
| fragrance | 0.10 | — |
| d.i. water | q.s. | — |
| potassium salt of cyclohexyl hydroxyl | — | 2.0 |
| diazenium-1-oxide (30%) | | |
| Luvitec VA64W | — | 8.0 |
| d.i. water | — | q.s. |
| pH | 13.68 | 8.5 |

| | |
|---|---|
| pH of mixture | 13.45 |

Example 3B

| | | second |
|---|---|---|
| | first aqueous | aqueous |
| | composition | composition |
| | (% wt.) | (% wt.) |
| sodium hypochlorite (13%) | 23.07 | — |
| sodium hydroxide (25%) | 1.6 | — |
| sodium chloride | 2.0 | — |
| lauryl dimethyl amine oxide (30% | 2.0 | — |
| active) | | |
| fragrance | 0.10 | — |
| d.i. water | q.s. | — |
| potassium salt of cyclohexyl hydroxyl | — | 2.0 |
| diazenium-1-oxide (30%) | | |
| Luvitec VA64W | — | 8.0 |
| d.i. water | — | q.s. |
| pH | 13.5 | 8.5 |

| | |
|---|---|
| pH of mixture | 13.22 |

Example 3C

| | | second |
|---|---|---|
| | first aqueous | aqueous |
| | composition | composition |
| | (% wt.) | (% wt.) |
| sodium hypochlorite (13%) | 38.46 | — |
| sodium hydroxide (25%) | 1.6 | — |
| sodium chloride | 2.0 | — |
| lauryl dimethyl amine oxide (30% | 2.0 | — |
| active) | | |
| fragrance | 0.10 | — |
| d.i. water | q.s. | — |
| potassium salt of cyclohexyl hydroxyl | — | 2.0 |
| diazenium-1-oxide (30%) | | |
| Luvitec VA64W | — | 4.0 |
| d.i. water | — | q.s. |
| pH | 13.68 | 8.52 |

| | |
|---|---|
| pH of mixture | 13.44 |

Example 3D

| | | second |
|---|---|---|
| | first aqueous | aqueous |
| | composition | composition |
| | (% wt.) | (% wt.) |
| sodium hypochlorite (13%) | 38.46 | — |
| sodium hydroxide (25%) | 1.6 | — |
| sodium chloride | 2.0 | — |
| lauryl dimethyl amine oxide (30% | 2.0 | — |
| active) | | |
| fragrance | 0.10 | — |
| d.i. water | q.s. | — |
| potassium salt of cyclohexyl hydroxyl | — | 2.0 |
| diazenium-1-oxide (30%) | | |
| Luvitec VA64W | — | 1.4 |
| d.i. water | — | q.s. |
| pH | 13.68 | 8.58 |

| | |
|---|---|
| pH of mixture | 13.45 |

Example 3E

| | | second |
|---|---|---|
| | first aqueous | aqueous |
| | composition | composition |
| | (% wt.) | (% wt.) |
| sodium hypochlorite (13%) | 23.07 | — |
| sodium hydroxide (25%) | 1.6 | — |
| sodium chloride | 2.0 | — |
| lauryl dimethyl amine oxide (30% | 2.0 | — |
| active) | | |
| fragrance | 0.10 | — |
| d.i. water | q.s. | — |
| potassium salt of cyclohexyl hydroxyl | — | 2.0 |
| diazenium-1-oxide (30%) | | |
| Luvitec VA64W | — | 1.4 |
| d.i. water | — | q.s. |
| pH | 13.5 | 8.58 |

| | |
|---|---|
| pH of mixture | 13.39 |

Thereafter for each of the foregoing, equal amounts of first aqueous composition and second aqueous composition were supplied to separate portions of a dual-chamber bottle formed of a flexible thermoplastic material, and which was further provided with a pump-spray apparatus which was manually operated by a trigger and ensured both the delivery of approximately equal amounts of the first aqueous composition and second aqueous composition with each pump stroke, and ensure mixing of the first aqueous composition with the second aqueous composition after leaving the respective individual nozzles used to dispense the said compositions thus forming the hard surface treatment composition.

The identity of the individual constituents indicated above is listed on the following Table 1 wherein is indicated the generic name, the commercial preparation used, the percent active weight (% w/w basis) of the compound identified by the generic name, and in some cases the supplier of the commercial preparation:

TABLE 1

| | |
|---|---|
| sodium hypochlorite (13% active) | sodium hypochlorite (13% wt. active) |
| sodium hydroxide (25% active) | sodium hydroxide, rayon grade |
| | (25% wt. active) |
| sodium chloride | anhydrous sodium chloride |
| lauryl dimethyl amine oxide (30% | lauryl dimethyl amine oxide (30% wt. |
| active) | active) supplied as Ammonyx LO or |
| | Surfac A030 |
| fragrance | proprietary composition of its |
| | respective supplier |
| d.i. water | deionized water |
| potassium salt of cyclohexyl | supplied as Protectol KD (30% wt. |
| hydroxyl diazenium-1-oxide (30%) | active) (ex. BASF) |
| Luvitec VA64W | vinylpyrrolidone/vinyl acetate |
| | copolymer in aqueous solution |
| | (50% wt. active) (ex. BASF) |
| silane (40%) | supplied as Silane IE6683 |
| | (40% wt. active) (ex. Dow Corning) |
| | described as a suspension/emulsion |
| | comprising: silicic acid, |
| | diethoxyoctylsilyl trimethylsilyl ester; |
| | N-octyltriethoxysilane; polyethylene |
| | oxide lauryl ether; aminofunctional |
| | siloxane |

Certain of the foregoing compositions were tested to evaluate their fungicidal and fungistatic efficacy. Comparative formulations were also evaluated to provide a side-by-side comparison of relative efficacy.

### Test A: Evaluation of Fungicidal Activity on Non-porous Hard Surfaces:

The fungicial activity of compositions was evaluated in accordance with the following general protocol. This test was intended to determine the efficacy of compositions to kill Aspergillus niger (ATCC 16404) on hard, nonporous surfaces.

Several media and reagents were prepared for use in this test.

Sabourand 4% dextrose agar solution was prepared in 100 mL (mL=milliliter) aliquots, and sterilized at 121° C. for 15 minutes, after which it was ready for use.

An Aspergillis harvesting solution was prepared from 8.9 g of sodium chloride, and 0.5 g of Tween 80 to which was added sufficient purified water to provide a 1 L (L=litre) stock solution. This stock solution was dispensed in 9 mL aliquots and sterilized at 121° C. for 15 minutes, after which it was ready for use.

A 2% water agar was prepared from 20 g of No. 3 agar to which was added sufficient water to form a 1 L stock solution. This stock solution was dispensed in 100 mL aliquots and sterilized at 121° C. for 15 minutes, after which it was ready for use.

Sabourand Neutralizer Broth was prepared from 30 g of Sabouraud 2% dextrose broth, 10 g of Tween 80, 3 g of lecithin, and 5 g of sodium thiosulfate to which was added sufficient purified water to form a 1 L stock solution. This stock solution was dispensed in 100 mL aliquots and sterilized at 121° C. for 15 minutes, after which it was ready for use.

Czapek Dox liquid medium was formed according to standardized manufacturer instructions and was dispensed in 20 mL aliquots and sterilized 121° C. for 15 minutes, after which it was ready for use.

Maximum recovery diluent (Merck 53471) was prepared according to standardized manufacturer instructions and was dispensed in 20 mL aliquots and sterilized at 121° C. for 15 minutes, after which it was ready for use.

For the test protocol, stock cultures of Aspergillus niger (ATCC 16404) were prepared and maintained on Sabouraud dextrose agar slopes. A conidial suspension containing approximately 10⁸ spores/mL was used to inoculate 10-12 Sabouraud dextrose agar slopes which were incubated at 22° C. for 7-14 days until hyphal growth was evident. Preparation of the spore test suspension was conducted as follows; 5-10 mL of sterile harvesting solution was applied to all of the 10-12 slopes and the surface was rubbed with the round end of a sterile plastic loop to detach his many of the conidiospores as possible from the surface of the slope. Subsequently, the liquid was transferred from the slope to a second slope and the process was repeated, detaching the conidispores in the same way. This process was repeated until all of the slopes had been washed with the same 5-10 mL harvesting solution. Where, during the foregoing protocol a lack of the harvesting solution was evident, a small amount of fresh harvesting solution may have been added to maintain the initial volume of the harvesting solution. Subsequently, in order to remove spore chains and hyphal elements from the recovered suspension containing the conidispores the suspension was filtered through a sterile non-absorbent cotton wool filter into a sterile bottle. If necessary, an additional amount of a sterile harvesting solution may have been used to wash the filter so to assure maximum recovery. Subsequently, the spore concentration in this resultant conidial suspension was determined by performing serial 1 mL dilutions in 9 mL of the maximum recovery diluent until the concentrations were reduced to 10⁻⁷. These dilutions were plated as 1 mL pour plates using Sabouraud dextrose agar, and the plates were incubated at 22° C. for up to five days.

Test substrates were prepared by the following protocol. Five standard glazed ceramic tiles (2.5 cm×2.5 cm) were washed with acetone, rinsed in purified water, and a washed again with acetone. The surface of each of the tiles was sterilized with a 70% aqueous ethanol preparation and thereafter the tiles were dried in a laminar flow cabinet. Subsequently, the sterile tiles were then removed and placed into individual sterile petri dishes which were immediately covered.

Separate test substrates using glass slides were also prepared according to the following protocol. Five standard flat laboratory glass slides (2.5 cm×2.5 cm) were washed with a 5% (v/v) solution of anionic detergent, e.g, Decon 90, following by rinsing with copious amount of distilled water. The slides were placed vertically in order to drain and they were then air dried in a laminar flow cabinet. Finally the glass slides were sterilized in a dry heat oven in glass Petri dishes which after sterilization were then removed from the oven, and immediately covered.

Next, a standardized spore suspension was prepared by transferring one of milliliter of the conidial spore suspension of Aspergillus niger into a 20 mL aliquot of sterile Czapek liquid medium which had been previously prepared, and the mixture was agitated to disperse the spores within the medium thus forming a test spore suspension. Thereafter using a standard laboratory pipette, the prepared test spore suspension at a spore concentration of 10⁸ spores per ml and an inoculum volume of 10 μL was transferred to the top of each of the tiles in the covered petri dishes, as well as each of the glass slides in the covered petri dishes, viz, the test substrates, and spread evenly using the tip of the pipette in order to inoculate the tile, after which the cover of the petri dish was immediately replaced. This process was repeated for each of the test substrates in order to inoculate each of the test substrates, viz., the prepared ceramic tiles and the prepared glass tiles. Subsequently, the tiles were allowed to dry for 40-60 minutes at 37° C.

Next, each of the prepared inoculated test substrates were sprayed individually with a quantity of a test composition in accordance with the following general protocol. A quantity of a test composition as described above was provided to a trigger spray bottle having dual chambers and having a dual trigger spray head, each of the one of each of the separate trigger spray heads being supplied by either the first aqueous composition or the second aqueous composition as described above. As the trigger spray heads were essentially identical, their volumetric delivery rate was also considered to be the same to us, thus a 1:1 volumetric ratio of the first aqueous composition: second aqueous composition was provided when both of the trigger spray heads were simultaneously pumped. More simply stated, each of the first aqueous composition and the second aqueous composition were provided to the test susbstrate in equal volumetric amounts. In order to test each of the test substrates, first the petri dish cover was removed, and then a quantity of the test composition was dispensed at a distance of approximately 10-15 cm from the surface of the ceramic tile or glass slide, which was horizontally positioned on top of a laboratory bench top. The respective angle between the tip of the trigger spray nozzles and the top surface of the test substrate was approximately 45°. The total amount of the test composition delivered in this manner was between about 6 and 9 mL for each application. Immediately thereafter, the test substrate was positioned substantially vertically in order to allow the applied test composition to run downwardly from the surface of the test substrate. Subsequently, following a 10 minute interval from the time at which the test composition was originally applied to each of the test substrate surfaces, using flamed forceps, each of the test substrates was individually transferred to separate sterile laboratory containers containing 20 mL aliquots of the previously prepared Sabourand neutralizer broth, and the laboratory containers were swirled and agitated in order to flow over the treated test substrate surface, and then they were incubated for at least three days at 22° C.

To verify the foregoing protocol, the foregoing test was performed also on test substrates of both types, namely ceramic tiles and glass slides, which had been inoculated using the conidial suspension but which had not been sprayed using a test composition. This ensured that the specific batch of the conidial suspension was biologically active.

Thereafter, the cidal effectiveness of the test formulations after three days of incubation was determined. This evaluation was performed by visual observation of the presence or absence of fungal growth within each laboratory container of neutralizer broth. Complete fungicidal activity was determined when all replicates (5 replicates) were observed to be free from fungal growth.

Compositions according to the invention as well as several comparative compositions were tested according to Test A; the identity of these compositions and their fungicidal efficacy are reported on the following Table A. Rating of the fungicidal effectiveness is indicated as the number of replicates of 5 total replicates on which fungal growth was observed. Thus a rating of “5” is to be understood that all of the 5 replicates exhibited fungal growth and concurrently no fungicidal effectiveness, while a rating of “0” indicated that no fungal grown was observed on any of the 5 total replicates, thus indicating excellent fungicidal efficacy.

It is again noted that in the test, total amount of each of the test composition delivered in this manner was between about 6 and 9 mL which was formed by spraying approximately equal amounts of the first aqueous composition and the second aqueous composition onto each of the test tile surfaces during which spraying and upon contact with the hard surface were the first aqueous composition and the second aqueous composition mixed to form the hard surface treatment composition.

Comparative compositions are identified the letter “C” followed by a digit, while example compositions falling within the scope of the invention are identified by the letter “E” followed by a digit; the example compositions also corresponds the foregoing examples described above.

TABLE A

| | | Number of | Number of |
|---|---|---|---|
| | | replicates | replicates |
| | | exhibiting | exhibiting |
| | | fungal growth | fungal growth |
| | | (glass slides) | (ceramic tiles) |
| C1 | 1% aqueous solution of Protectol | 4 | 5 |
| | KD | | |
| C2 | Hypochlorite base blend, 2.5% | 2 | 2 |
| | available chlorine | | |
| C3 | Hypochlorite base blend, 2% | 0 | 2 |
| | available chlorine | | |
| C4 | Hypochlorite base blend, 1.5% | 1 | 1 |
| | available chlorine | | |
| C5 | Hypochlorite base blend, 1.25% | 1 | 3 |
| | available chlorine | | |
| C6 | Hypochlorite base blend, 1% | 2 | 1 |
| | available chlorine | | |
| C7 | Hypochlorite base blend, 0.5% | 3 | 3 |
| | available chlorine | | |
| C8 | 1% Protectol KD, 2% Silane | 3 | 5 |
| | IE6683, no chlorine, in aqueous | | |
| | solution | | |
| C9 | 1% Protectol KD, 2% Luvitec | 5 | 5 |
| | VA64W, no chlorine, in aqueous | | |
| | solution | | |
| E1A | Example 1 | 0 | 0 |
| E2A | Example 2A | 0 | 0 |
| E2B | Example 2B | 0 | 0 |
| E2C | Example 2C | 1 | 0 |
| E2D | Example 2D | 0 | 0 |
| E3A | Example 3A | 0 | 0 |
| E3B | Example 3B | 0 | 0 |
| E3C | Example 3C | 1 | 0 |
| E3D | Example 3D | 0 | 0 |
| E3E | Example 3E | 0 | 0 |

The concentrations of the comparative examples “C” were based on the concentration of the specific composition as applied onto the tested surface.

The composition of the “Hypochlorite base blend” in the foregoing table was the following composition wherein the amounts of the sodium hypochlorite and water were conversely varied in order to provide the amount of available free chlorine indicated on Table A, while the amounts of the remaining constituents which were additionally present remained constant.

The identity of the individual constituents used to form the “Hypochlorite base blend” are as identified on Table 1.

| Hypochlorite base blend | % w/w |
|---|---|
| lauryl dimethyl amine oxide (30%) | 2 |
| sodium hydroxide (25%) | 1.6 |
| sodium chloride | 2 |
| sodium hypochlorite (13%) | varies |
| d.i. water | q.s. |

From the foregoing results reported on Table A it has been surprisingly discovered that aqueous compositions containing bleach absent the (N-organyldiazeniumdioxy) compound, and aqueous compositions containing the (N-organyldiazeniumdioxy) compound but in the absence of bleach performed poorly in the past. Surprisingly, the compositions according to the invention containing both the oxidizing agent, namely bleach, and the (N-organyldiazeniumdioxy) compound demonstrated surprising and unexpected fungicidal efficacy.

From the foregoing results reported on Table A it has also been surprisingly discovered that aqueous compositions containing the (N-organyldiazeniumdioxy) compound with the surface modifying constituent but in the absence of the oxidizing constituent, viz., bleach, performed poorly in the past. Surprisingly, the compositions according to the invention containing both the oxidizing agent, namely bleach, and the (N-organyldiazeniumdioxy) compound demonstrated surprising and unexpected fungicidal efficacy.

### Test B: Evaluation of Durable Fungistatic Activity on Non-porous Hard Surfaces

The fungistatic activity of compositions according to one or more of the foregoing examples was evaluated in accordance with the following general protocol. This test was intended to determine the efficacy of compositions to retard the growth of Aspergillus niger (ATCC 16404) on hard, nonporous surfaces over a given time period.

Several media and reagents were used in the present test, which were identical to those listed and described above with reference to “Test A: Evaluation of fungicidal activity on non-porous hard surfaces:” Similarly, For the present test protocol, stock cultures of Aspergillus niger (ATCC 16404) were prepared and maintained on Sabouraud dextrose agar slopes according to the prior general protocol relating to the preparation of working conidial suspensions also described with reference to the foregoing “Test A: Evaluation of fungicidal activity on non-porous hard surfaces:”

According to the present test, test substrates were prepared by the following protocol. five standard glazed ceramic tiles (2.5 cm×2.5 cm) were washed with acetone, rinsed in purified water, and a washed again with acetone. The surface of the tiles were sterilized with a 70% aqueous ethanol preparation and thereafter the tiles were dried in a laminar flow cabinet. Subsequently, the sterile tiles were then removed and placed into sterile petri dishes which were immediately covered.

Separate test substrates using glass slides were also prepared according to the following protocol. Five standard flat laboratory glass slides (2.5 cm×2.5 cm) were washed with a 5% (v/v) solution of anionic detergent, e.g, Decon 90, following by rinsing with copious amount of distilled water. The slides were placed vertically in order to drain and they were then air dried in a laminar flow cabinet. Finally the glass slides were sterilized in a dry heat oven in glass Petri dishes which after sterilization were then removed from the oven, and immediately covered.

Subsequently, two large sterile petri dishes containing sterile filter paper were provided. Into each of the two sterile petri dishes were either placed five sterile tiles or five glass slides which had been previously prepared. Next, each of the prepared sterilized test substrates, viz., the ceramic tiles or the glass slides, was sprayed individually with a quantity of a test composition in accordance with the following general protocol. A quantity of a test composition as described above was provided to a trigger spray bottle having dual chambers and having a dual trigger spray head, each of the individual trigger spray heads being supplied by either the first aqueous composition or the second aqueous composition as described above. As the trigger spray heads were essentially identical, their volumetric delivery rate was also considered to be the same to us, thus a 1:1 volumetric ratio of the first aqueous composition: second aqueous composition was provided when both of the trigger spray heads were simultaneously pumped. More simply stated, each of the first aqueous composition and the second aqueous composition were provided to each test substrates in equal volumetric amounts. In order to test each of the test substrates, first the petri dish cover was removed, and then a quantity of the test composition was dispensed by spraying at a distance of approximately 10-15 cm from the surface of the test substrates, which test substrates was horizontally positioned on top of a laboratory bench top. The respective angle between the tip of the trigger spray nozzles and the top surface of the test test substrates was approximately 45°. The total amount of the test composition delivered in this manner was between about 6 and 9 mL for each application. Immediately thereafter, the petri dish containing the test substrates was covered, and then the petri dish containing the test substrates was positioned substantially vertically in order to allow the excess applied test composition to run downwardly from the surface of the test substrate. Subsequently, each of the test substrates was transferred to a second fresh sterile petri dish containing sterile filter paper which was then provided to a laminar flow cabinet wherein the test substrates were treated at 20° C. for a time period of about 40 minutes.

The foregoing test protocol was repeated 10 times for each of the tested compositions according to the invention using 5 individual ceramic tiles and 5 individual glass tiles as previously prepared. The foregoing test protocol was also repeated 5 times using 5 individual ceramic tiles and 5 individual glass slides as previously prepared but which were sprayed with sterile water in order to provide comparative results, and to ensure that the specific batch of the conidial suspension was biologically active.

Next, the test substrates were individually placed into 1 litre of sterile distilled water and gently agitated for 280 minutes (280 minutes was calculated based upon twenty eight 10 minute showers within a 4 week period). After this time the test substrates were removed using sterile forceps and placed into individual sterile Petri dishes which were positioned substantially vertically in order to allow the water to drain. Subsequently each of the test substrates was transferred to a fresh Petri dish containing sterile filter paper and placed into a laminar flow cabinet where the tiles were dried at 20° C. for a period of about 40 minutes.

Next, a standardized spore suspension was prepared by transferring one of milliliter of the conidial spore suspension of Aspergillus niger into a 20 mL aliquot of sterile Czapek liquid medium which had been previously prepared, and the mixture was agitated to disperse the spores within the Czapek liquid medium and to form a test spore suspension. Thereafter using a standard laboratory pipette, the prepared test spore suspension at a spore concentration of 10⁸ spores per ml and an inoculum volume of 10 μL was transferred to the top of each of the test substrates in the covered petri dishes, spread evenly using the tip of the pipette in order to inoculate the test substrates, after which the cover of the petri dish was immediately replaced. This process was repeated for each of the 10 test substrates in order to inoculate each of the test substrates. Subsequently, the test substrates were allowed to dry for 60 minutes at 37° C., leaving the covers of each petri dish slightly ajar.

Next, each of the test substrates were removed using flamed forceps from the petri dish, and with their inoculated surface facing upwards were transferred to individual petri dishes containing hardened sterile water agar, and the covers of the petri dishes replaced.

Thereafter, the individual petri dishes containing the respective test substrates were transferred to a sealable, plastic container which had been lined with tissue paper moistened in water. The test substrates were thus incubated within the said plastic container at 22° C. for a time period of at least four weeks. During the foregoing incubation period, the test substrates were evaluated at 7 day intervals for fungicidal growth. Observations were made and recorded at seven day intervals and the presence or absence of visually observable fungal growth on the surface of the test substrates was noted. Where no visible growth was evident to the unaided eye of a human observer, at the end of the test, each of the test substrates upon which no visible fungal growth was observed were additionally evaluated using a laboratory magnifier at 15× magnification in order to confirm the absence of fungal growth. The identity of the formulations tested, and the results observed are reported on the following Table B.

The use of this water soaking step described above was for the purpose of simulating actual weathering of surfaces in a bathroom under heavy useage conditions, specifically shower stalls and bathtub enclosures wherein bath water or more usually shower water being dispensed from a showerhead impinges on the surface of the tile. The above test represents a harsh simulating “weathering cycle” for the hard surfaces treated with the tested compositions and also provides a useful indicia as to the expected durability of the composition and its efficacy as a fungicide and/or fungistat under such conditions.

As before, in the following table comparative compositions are identified the letter “C” followed by a digit, while example compositions falling within the scope of the invention are identified by the letter “E” followed by a digit; the example compositions also corresponds the foregoing examples described above. The composition of the “Hypochlorite base blend” in the foregoing table was the following composition wherein the amounts of the sodium hypochlorite and water were conversely varied in order to provide the amount of available free chlorine indicated on Table A, while the amounts of the remaining constituents remained constant. The identity of the individual constituents used to form the “Hypochlorite base blend” are as identified above in the discussion relating to Table 1.

TABLE B

| | | Glass test substrate | | | | Tile test substrate | | | |
|---|---|---|---|---|---|---|---|---|---|
| | | 7 | 14 | 21 | 28 | 7 | 14 | 21 | 28 |
| | | days | days | days | days | days | days | days | days |
| C3 | Hypochlorite base blend, | 5 | 5 | 5 | 5 | 5 | 5 | 5 | 5 |
| | 2.5% available chlorine | | | | | | | | |
| C4 | Hypochlorite base blend, | 5 | 5 | 5 | 5 | 5 | 5 | 5 | 5 |
| | 1.5% available chlorine | | | | | | | | |
| E2A | Example 2A formulation | 3 | 5 | 5 | 5 | 4 | 5 | 5 | 5 |
| E3A | Example 3A formulation | 0 | 0 | 0 | 2 | 3 | 4 | 4 | 4 |
| E2E | Example 2E formulation | 5 | 5 | 5 | 5 | 5 | 5 | 5 | 5 |
| E3B | Example 3B formulation | 5 | 5 | 5 | 5 | 2 | 2 | 2 | 2 |
| E2C | Example 2C formulation | 0 | 0 | 0 | 0 | 2 | 2 | 2 | 2 |
| E3D | Example 3D formulation | 0 | 0 | 0 | 0 | 0 | 0 | 0 | 2 |
| E2D | Example 2D formulation | 4 | 4 | 4 | 4 | 3 | 3 | 3 | 3 |
| E3E | Example 3E formulation | 5 | 5 | 5 | 5 | 3 | 3 | 3 | 3 |

A composition was considered to provide acceptable fungistatic activity when all 5 replicates of a test substrate were observed to be free from fungal growth. As before, rating of the fungicidal effectiveness is indicated as the number of replicates of 5 total replicates on which fungal growth was observed. Thus a rating of “5” is to be understood that all of the 5 replicates exhibited fungal growth and concurrently no fungicidal effectiveness, while a rating of “0” indicated that no fungal grown was observed on any of the 5 total replicates, thus indicating excellent fungicidal efficacy.

As can be seen from the foregoing results of Table B, most of the compositions according to the invention provided a range of fungistatic activity extending from poor activity (e.g., E2E) to excellent fungistatic activity, (e.g. E2C and E3D) with better results observed with increased concentrations of the hypochlorite constituent being present in the hard surface treatment composition, with particularly good results achieved at levels of at least about 2.5% wt. hypochlorite in conjunction with the Protectol KD material being present.

### Test C: Assessment of Fungal Removal and Prevention of Fungal Growth on Hard Surfaces

The fungistatic activity of compositions according to one or more of the foregoing examples was evaluated in accordance with the following general protocol. This test was intended to determine the efficacy of compositions to retard the growth of a mixture of various fungal on hard, nonporous surfaces over a given time period, under high humidity conditions and subjected to periodic washing with a surfactant containing aqueous mixture. Such simulated adverse heavy useage conditions.

In accordance with the present test, a plurality of test panels were constructed from stainless steel panels measuring approximately 9 cm×14 cm onto which were adhered evenly spaced white ceramic nonporous tiles each having a dimension of approximately 2.5 cm×2.5 cm., with the spaces between the adjacent tiles and as well as the spaces between the tiles and the margin of the stainless steel plate being sealed with a grout composition. The grout composition was a commercially available white grout, ARDEX C2 (ex. Ardex UK Ltd., United Kingdom) which was selected due to the fact that it did not incorporate a fungicide or fungicidal constituent among its constituents.

The selection was made so as not to hamper the evaluation of the fungicidal efficacy of the compositions to be tested. After grouting and smoothing the surface of the tiles on the stainless steel tray, the grout was allowed to harden in a conventional manner.

Prior to the complete hardening of the grout, the alkalinity of the test panels which was originally determined to be approximately at a pH of about 14 was adjusted by sealing the test panels into a polyethylene bag and thereafter filling the bag with carbon dioxide where they were maintained for four hours.

Subsequently, the test panels were removed from the polyethylene bag, sprayed with water, and then returned to the polyethylene bag which was sealed wherein a further quantity of carbon dioxide was introduced into the polyethylene bag. The washed test panels were thus maintained under a carbon dioxide atmosphere for 24 hours, and if necessary additional carbon dioxide was introduced into the sealed polyethylene bag in order to maintain the presence of carbon dioxide in the sealed bag. Subsequently, the polyethylene bag was opened, and the test panels were removed. Prior to any use of the test panels, the surface alkalinity of the test panels was evaluated in order to ensure that the surface alkalinity was in the range of pH 7.

Separately, a mixed inoculum was prepared from the following spore species:

| | |
|---|---|
| Alternaria alternate | IMI 342924 |
| Aspergillus versicolor | IMI 45554 |
| Aureobasidium pullulans | IMI 45533 |
| Cladosporium cladosporioides | IMI 178517 |
| Penicillum purpurogenum | IMI 178519 |
| Phoma violacea | IMI 49948ii |
| Rhodotorula rubra | NCYC 1695 |
| Sporobolomyces roseus | NCYC 717 |
| Stachybotrys chartarum | IMI 82021 |
| Ulocladium atrum | IMI 79906 |
| Aspergillus flavus | CMI 91856ii |
| Aspergillus terreus | CMI 095928 |
| Aspergillus niger | CMI 91855ii |
| Penicillum funiculosum | CMI 211742 |
| Penicillum ochrachloron | IMI 061271 |
| Scopularopsis brevicaulis | PRA isolate 5 (ex. Paint Research |
| | Association, UK, culture collection) |
| Trichderma viride | IMI 342926 |
| Paecilomyces variotti | IMI 114930 |
| Cladosporium herbarum | IMI 378363 |
| Cladosporium sphaerospermum | IMI 170353 |

in accordance with the following protocol.

Stock cultures of these organisms were grown on potato dextrose agar slopes for 14 days at 25° C. and the inoculum was prepared according to the following protocol.

Using a sterile disposable loop, growth for each organism was removed from the agar slope and transferred to a number of Petri dishes containing potato dextrose agar and the organism was spread over the surface of the agar. The plates were then incubated at 25° C. for at least 14 days until well sporulating cultures were obtained.

Spore suspensions of each of the foregoing species were prepared by adding 10 mL of sterile distilled water containing 0.001% of Tween 80 (used as a wetting agent) to each culture and then dislodging the spores with a further sterile disposable loop. Large undispersed lumps of spores were removed by filtration through a sterile filter.

Thereafter a haemocytometer was use to determine the number of spores present in the suspension, and the number of spores were adjusted accordingly to ultimately provide a level of 104 spores/milliliter. Equal volumes of the spore suspensions of the foregoing species were mixed to generate the final spore inoculum used in the subsequent steps of the test.

In the next step of the tests, the previously prepared tiled and grouted test panels were first checked to ensure that their surface pH was 7.

Each test product based on one or more of the example formulations taught herein, as well as control products based on “control” formulations which were produced for comparative purposes were applied to the surface of the previously prepared test panels in an identical manner, and the subsequent treatment of, and the final reading of the test panels was identical to regardless of the nature of the product being evaluated.

For each product being evaluated, approximately uniform quantities of test products were applied to the surface of a test panel by a spraying application step. Application of test products were performed using a conventional trigger spray device, attached to a bottle wherein the nozzle of the trigger spray was maintained at a distance of approximately 20-25 centimeters and at an angle of approximately 45° from the horizontal, onto the upwardly facing tiled surfaces of the test panels and approximately 10 trigger spray pumps, dispensing approximately 12-15 mL of each product was used to substantially saturate the surface of each test panel.

The test compositions based on an example composition were formed by mixing equal parts of their respective first aqueous compositions and their second aqueous compositions immediately before being sprayed from the trigger spray, which approximated the effect of mixing of the respective first aqueous compositions and their second aqueous compositions as if they were separately dispensed from separate trigger spray pumps and mixed in flight to a surface, or mixed on a hard surface on which they were simultaneously applied. Test products based on comparative example compositions were simply supplied to the bottle and dispensed via the trigger spray bottle.

Subsequently, the sprayed upon treated test panels were lifted, and stood vertically in a suitable rack for 10 minutes in order to provide the maximum opportunity for access product applied to the surface to float downwardly and off of the test panel. After this 10 minute interval, each panel was lightly wiped using a sterile laboratory cloth using 3 downward strokes from the top to the bottom of the tile; the purpose of the use of the sterile laboratory cloth was to simulate any wiping operation as might be met in a consumer household and also, to remove any excess tested product from the surface.

Next, sterile distilled water was then sprayed onto the vertical panels in order to completely saturate the surface, and also to simulate a rinse step subsequent to the application of the product. The sterile distilled water was supplied using a very similar or identical trigger spray pump as used to dispense a test product, and again 10 trigger spray pumps, dispensing approximately 12-15 mL of distilled water. After which the test panels were then dried horizontally for 40 minutes at a temperature of approximately 37° C. This step also provided an opportunity for the formation of the surface coating believed to be provided by the surface modifying constituent is present in a tested composition.

Next, the tiled panels were placed horizontally on a laboratory surface, and immediately thereafter these services were inoculated from the final spore inoculum by applying through a trigger spray bottle, dispensing the same by two manual pumps at the trigger spray which delivered approximately 2.5 mL onto the surface of each of the test panels. Next, the panels were allowed to dry at room temperature for approximately 90 minutes, and subsequently the inoculated test panels were placed into a humidity chamber on a rack which ensured that the bottom of each of the test plates was maintained above the level of the water bath.

The humidity chamber was a device which was essentially a covered test tank wherein the base of the test tank included a thermostatically controlled water bath which maintained an ambient water temperature and further maintained that the interior temperature of the humidity chamber at about 4° C.+/−1° C. above the ambient temperature of the room in which the humidity chamber was placed. The ambient temperature of this room was maintained to be at 23° C.+/−2° C. during the tests. Further, the temperature control of the humidity tank was operated by a timer wherein, the heaters in the humidity tank were controlled such that power was supplied to the heaters for two hours, and then power was disengaged for 10 hours. This 12 hour cycle on/off power cycle was repeated throughout the duration of the test. The humidity chamber itself was essentially hermetically sealed when in a closed condition, but could be readily open to remove and replace test panels at his specific intervals as described below. Further, the humidity chamber included in a rack within its interior and at the base, which allowed for the vertical positioning and retention of a plurality of test panels.

Vertical positioning of the test panels allowed for the maximum runoff of surface water condensing upon the surface of the test panels within the humidity chamber and also simulated vertical tiled surfaces as might be found in bathrooms, kitchens, and the like. Additionally, water was continuously present in the base of the test tank throughout the duration of the test.

Additionally, 2 test panels which had not been treated using a test composition as described were also used through the test described as “control” samples and to also verify the viability of the spore inoculum used to inoculate test panels.

Further, for each tested composition, four replicate test panels were used. At a time 24 hours after the initial inoculation, half of the tiles tested were subjected to a shampoo conditioning treatment. In this treatment, two of the four panels which had been treated for each of the separate tested formulations, as well as one of the untreated, control test panels were removed from the humidity chamber and positioned vertically on a laboratory bench top. Next, the tiled surfaces of the test panels were sprayed with a shampoo solution, which is formed by mixing 0.1 grams of a conventional hair shampoo composition in 1 L of sterile distilled water which shampoo solution was provided in any conventional trigger spray bottle. The trigger spray was very similar, or identical to the trigger spray pump as used to dispense a test product, and again 10 trigger spray pumps, dispensing approximately 12-15 mL of the shampoo solution was supplied to the tiled and grouted surface of each test panel. The test panels were allowed to drain briefly, and again were subsequently sprayed with sterile deionized water using the same trigger spray as used previously to again deliver approximately 12-

10 mL of the sterile deionized water. Excess water was allowed to drain off the surface of the tiles after which these tiles were returned to the interior of the humidity chamber.

The remaining tiles were not subjected to this shampoo conditioning treatment.

Also, throughout the duration of the test, all of the tiled test panels were reinoculated on a weekly basis using a fresh batch of the final spore inoculum prepared as described above by applying the same from a trigger spray bottle also as described previously. This simulated in the availability of fresh fungal spores in a kitchen or lavatory environment.

Testing of the inoculated tiled test panels, both with the shampoo conditioning treatment, and without the shampoo conditioning treatment, as well as that of the two control test panels continued for a total time of 84 days. During this time period, each of the test panels were removed from the humidity chamber on days 14, 21, 28, 35, 42, 49, 63 and on the last, 84th day and evaluated for surface fungal growth.

The evaluation of surface fungal growth on the surface of the tiles and/or grout was performed by visual observation using laboratory microscope having a magnification factor of 50× wherein the visual characteristics of the fungal growth on the respective test panels was observed and ranked according to the following scale:

| Score | Visual Characteristics |
|---|---|
| 0 | no visible fungal growth |
| 1 | slight trace of a fungal growth |
| 2 | visible fungal growth on 1-10% of test panel |
| 3 | visible fungal growth on 10-30% of test panel |
| 4 | visible fungal growth on 30-70% of test panel |
| 5 | visible fungal growth on 70-100% of test panel |

The results of these of visual assessment of compositions tested on the test panels according to the protocols described above are reported on accompanying the following Table C which identifies the specific composition being evaluated, as well compositions used for comparative purposes, namely test panel treated only with deionized water and used as “control” test panels, as well as a “Hypochlorite base blend” as described with reference to Table 1, supra, wherein the amount of hypochlorite was adjusted to provide an active chlorine concentration of 2.5% w/w. The results are also identified according to whether the test panels were subjected to the daily shampoo treatment conditioning steps as described above (labelled “shampoo conditioned”), or whether throughout the 84 day interval of the test they were not conditioned, (labelled “unconditioned”) in such a manner. The identity of the specific test compositions prefer to example formulations described above.

The results of these of visual assessment of compositions tested on the test panels according to the protocols described above are reported on accompanying the following Table C which identifies the specific composition being evaluated, as well compositions used for comparative purposes, namely test panel treated only with deionized water and used as “control” test panels, as well as a “Hypochlorite base blend” as described with reference to Table 1, supra, wherein the amount of hypochlorite was adjusted to provide an active chlorine concentration of 2.5% w/w. The results are also identified according to whether the test panels were subjected to the daily shampoo treatment conditioning steps as described above (labelled “shampoo conditioned”), or whether throughout the 84 day interval of the test they were not conditioned, (labelled “unconditioned”) in such a manner. The identity of the specific test compositions prefer to example formulations described above.

TABLE C

| day | day | day | day | day | day | day | day |
|---|---|---|---|---|---|---|---|
| 14 | 21 | 28 | 35 | 42 | 49 | 56 | 84 |

unconditioned

| | | | | | | | | |
|---|---|---|---|---|---|---|---|---|
| Example 2A | 2 | 2.5 | 2.5 | 2.5 | 2.5 | 2.5 | 2.5 | 4 |
| Example 3A | 1.5 | 2.5 | 2.5 | 2.5 | 2.5 | 2.5 | 2.5 | 3.5 |
| Example 2C | 2 | 3 | 3 | 3 | 3 | 3 | 3 | 3.5 |
| Example 3D | 2.5 | 3 | 3.5 | 3.5 | 4 | 4 | 4 | 4 |
| (comparative | 2 | 2.5 | 3 | 3 | 3.5 | 3.5 | 4 | 4 |
| example) | | | | | | | | |
| Hypochlorite | | | | | | | | |
| base blend, | | | | | | | | |
| 2.5% available | | | | | | | | |
| chlorine | | | | | | | | |
| (comparative | 2.5 | 3.5 | 4 | 4 | 4 | 4 | 4 | 4 |
| example) | | | | | | | | |
| d.i. water | | | | | | | | |

shampoo conditioned

| | | | | | | | | |
|---|---|---|---|---|---|---|---|---|
| Example 2A | 1 | 2 | 1 | 1.5 | 1.5 | 1.5 | 1.5 | 2.5 |
| Example 3A | 1 | 2 | 2 | 2 | 2 | 2 | 3 | 3.5 |
| Example 2C | 1 | 2 | 2 | 2 | 2 | 3 | 3 | 3.5 |
| Example 3D | 2 | 2 | 2 | 2 | 2 | 3 | 3 | 3 |
| (comparative | 1 | 2 | 2.5 | 2.5 | 3 | 3.5 | 4 | 4 |
| example) | | | | | | | | |
| Hypochlorite | | | | | | | | |
| base blend, | | | | | | | | |
| 2.5% available | | | | | | | | |
| chlorine | | | | | | | | |
| (comparative | 1.5 | 2.5 | 3 | 3 | 3 | 3.5 | 4 | 4 |
| example) | | | | | | | | |
| d.i. water | | | | | | | | |

As it will be understood by one of appropriate skill in the art that the foregoing protocol used in Test C is particularly severe especially in view of the fact that repeated inoculations and placement of the test panels in the humidity chamber are representative of on the one hand, extreme conditions for the retention of the test composition on the surface of the tile, while on the other hand concurrently being near ideal conditions for the rapid growth of fungi, it will then be understood that the results reported on Table C represent that the compositions according to the invention provide good efficacy and the longer-term resistance to the growth of fungi particularly over extended time periods, that is to say in excess of 14 days, and particularly in excess of 21 days. This can be determined by comparing the results of the de-ionized water treated samples and contrasting these to the compositions of the invention and their respective differences in performance. This difference is particularly striking when comparing the ratings of fungal growth for compositions according to the invention, and contrast to those treated by de-ionized water or the Hypochlorite base blend described supra, comprising 2.5% wt. hypochlorite, a very significant degree of disparity is present and is readily visible. With regard now to the shampoo conditions test plates, it is seen that at the same time interval, the relative differences between the visible rating of fungal growth on the tile and grout surfaces of the test plates treated with compositions according to the invention, as opposed to the compositions treated only with deionized water had lesser degrees of difference. However, this degree of differences nonetheless significant particularly in consideration of the fact that at longer time intervals despite repeated daily treatment with the daily shampoo conditioning the results achieved based on the use of the compositions of the invention were still significantly better than the those test plates treated only with the deionized water.

It is believed also quite significant to note that use of the compositions according to the invention also reduced the relative onset of fungal regrowth on the test plates particularly when one compares the results of the tests performed both with and without the daily shampoo conditioning treatment steps. This is important from a commercial and a consumer standpoint as, based on the fact that a typical consumer will clean that their bathroom at least every one or two weeks, the use of the compositions according to the invention are particularly well-suited and are shown to be effective in inhibiting fungal regrowth on such surfaces treated with compositions according to the invention, as opposed to those comparative compositions which were treated only with a de-ionized water. Thus, with this being said, it is realized then that the compositions according to the invention are particularly adapted to be used in conditions wherein cleaning of bathroom surfaces, kitchen surfaces, or other hard surfaces upon which the treatment composition has been applied is expected to be repeated at 1, 2, or at three-week periodic intervals. When used in this manner then, namely wherein the treatment composition according to the invention is reapplied at 1, 2, or even 3 week intervals, it will be understood that the prior application of the hard surface treatment composition of the invention provides a good retardation of fungal regrowth in the time interval between successive applications of the hard surface treatment compositions as taught herein. Thus, the compositions of the invention are particularly useful in a product, and/or a process for inhibiting the regrowth of fungi on a hard surface between applications of the product, particularly when reapplication of the product occurs at a time interval of up to four, preferably up to three, yet more preferably up to two, most preferably at approximately 1 week intervals between successive applications.

Although this invention has been shown and described with respect to the detailed embodiments thereof, it will be understood by those of skill in the art that various changes may be made and equivalents may be substituted for elements thereof without departing from the scope of the invention. In addition, modifications may be made to adapt a particular situation or material to the teachings of the invention without departing from the essential scope thereof. Therefore, it is intended that the invention not be limited to the particular embodiments disclosed in the above detailed description, but that the invention will include all embodiments falling within the scope of the appended claims.

1. A hard surface treatment composition which provides improved mold and/or fungi remediation properties formed from at least two aqueous mixtures or aqueous compositions which are admixed immediately or shortly prior to use or upon use wherein:
the first aqueous composition comprises an oxidizing constituent; and,
the second aqueous composition comprises a fungicide constituent which is one or more one or more (N-organyldiazeniumdioxy) compounds and/or metal salts thereof which may be generally represented by the following formula: 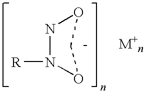
wherein:
R is C₁-C₆-alkyl, C₃-C₈-cycloalkyl or aryl,
M⁺ is a cation equivalent, and
n is an integer from 1 to 3.

2. A hard surface treatment composition according to claim 1 which further comprises a surface modifying constituent selected from:
a polymer having the formula 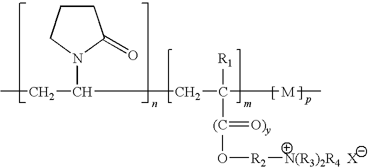
in which n represents from 20 to 99 and preferably from 40 to 90 mol %, m represents from 1 to 80 and preferably from 5 to 40 mol %; p represents 0 to 50 mol, (n+m+p=100); R₁ represents H or CH₃; y represents 0 or 1; R₂ represents —CH₂—CHOH—CH₂— or CₓH₂ₓ in which x is 2 to 18; R3 represents CH₃, C₂H₅ or t-butyl; R₄ represents CH₃, C₂H₅ or benzyl; X represents Cl, Br, I, ½ SO₄, HSO₄ and CH₃SO₃; and M is a vinyl or vinylidene monomer copolymerisable with vinyl pyrrolidone other than the monomer identified in [ ]ₘ;
water soluble polyethylene oxide;
polyvinylpyrrolidone;
high molecular weight polyethylene glycol;
polyvinylcaprolactam;
vinylpyrrolidone/vinyl acetate copolymer;
vinylpyrrolidone/vinyl caprolactam/ammonium derivative terpolymer, especially where the ammonium derivative monomer has 6 to 12 carbon atoms and is selected from diallylamino alkyl methacrylamides, dialkyl dialkenyl ammonium halides, and a dialkylamino alkyl methacrylate or acrylate;
polyvinylalcohol;
cationic cellulose polymer;
film-forming fatty quaternary ammonium compounds;
organosilicone quaternary ammonium polymers;
polyamide polymers.

3. A hard surface treatment composition according to claim 1 wherein the oxidizing constituent of the first aqueous composition is a bleach constituent or an oxidizing constituent.

4. A hard surface treatment composition according to claim 3 wherein the oxidizing constituent of the first aqueous composition is present in an amount in an amount of from about 0.001% wt. to about 10% wt., based on the total weight of the first aqueous composition of which it forms a part.

5. A hard surface treatment composition according to claim 1, wherein in the one or more (N-organyldiazeniumdioxy) compounds and/or metal salts;
M+ is a cation equivalent, or that portion of a polyvalent cation or a positively charged metal-atom-containing group which corresponds to a single positive charge.

6. A hard surface treatment composition according to claim 5 wherein in the one or more (N-organyldiazeniumdioxy) compounds and/or metal salts;
M⁺ is an alkali metal cation preferably Li⁺, Na⁺ or K⁺, or a bivalent cation, preferably Cu²⁺, Zn²⁺, Ni²⁺ and Co²⁺, or a trivalent cation, preferably Fe³⁺ or Al³⁺, or a monovalent metal-atom-containing groups.

7. A hard surface treatment composition according to claim 5 wherein the one or more (N-organyldiazeniumdioxy) compounds and/or metal salts are selected from bis-N-cyclohexyldiazeniumdioxy-copper, tris-N-cyclohexyldiazeniumdioxy-aluminium and a potassium salt of cyclohexyl hydroxyl diazenium-1-oxide.

8. A hard surface treatment composition according to claim 1 wherein the one or more (N-organyldiazeniumdioxy) compounds and/or metal salts may be represented by

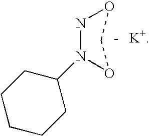

9. A hard surface treatment composition according to claim 1 wherein the at least first aqueous composition and the second aqueous composition are applied to a hard surface wherein the presence of mold and/or fungi are known or suspected 10 minutes or less subsequent to mixing, or mixing of the two mixtures directly on a surface upon a hard surface.

10. A method for the treatment of hard surfaces whereon the presence of mold and/or fungi is known or suspected, which method includes the step of applying an effective amount of the hard surface treatment composition according to claim 1 for the remediation of mold and/or fungi which may be present

11. A hard surface treatment composition according to claim 6 wherein in the one or more (N-organyldiazeniumdioxy) compounds and/or metal salts;
M⁺ is a tin-containing group of the formula R^{a}R^{b}R^{c}Sn⁺ in which R^{a}, R^{b} and R^{c} independently of one another are C₁₋₆-alkyl radicals.
